(19) United States
(12) Patent Application Publication
(10) Pub. No.: US 2009/0161920 A1
(43) Pub. Date: Jun. 25, 2009

(54) Biometric information acquisition apparatus, image acquisition apparatus, and electronic equipment

(75) Inventors: Kimiharu Kan, Ibaraki-shi (JP); Nobuhiro Umebayashi, Ibaraki-shi (JP); Masahiro Kishigami, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-shi (JP)

(21) Appl. No.: 12/314,665

(22) Filed: Dec. 15, 2008

(30) Foreign Application Priority Data
Dec. 25, 2007 (JP) 2007-332197
Dec. 25, 2007 (JP) 2007-332198
May 20, 2008 (JP) 2008-131747

(51) Int. Cl. G06K 9/00

(52) U.S. Cl. 382/115

(57) ABSTRACT

A biometric information acquisition apparatus includes a sensor that includes at least one pixel row formed from a plurality of pixels, and a drive mechanism that moves the sensor in a direction intersecting a pixel arrangement direction of the pixel row.

### BACKGROUND OF THE INVENTION

1. Field of the Invention

The present invention relates to a biometric information acquisition apparatus, an image acquisition apparatus, and electronic equipment.

2. Description of Related Art

With recent enhancement in information security protection, the progress in the technological development relating to biometric authentication has been significant. The biometric authentication is a technique that distinguishes a certain individual from other individuals based on determination as to whether the biometric information which is acquired from an inspection targeted individual matches prestored biometric information. Examples of the biometric authentication are identifying an individual based on the iris of a human pupil, identifying an individual based on the vein pattern of a human finger or the like, identifying an individual based on the fingerprint pattern, and so on.

In the biometric authentication, there are various merits and demerits depending on biometric information used for authentication. For example, the biometric authentication using the vein pattern has an advantage that forgery of authentication information is more difficult than the biometric authentication using the fingerprint pattern. On the other hand, the latter has a disadvantage that forgery of authentication information is easier than the former.

Japanese Unexamined Patent Application Publication No. 2001-119008 discloses an imaging apparatus that is used for the biometric authentication. In this imaging apparatus, the light source (100), the support (300) and the image authentication unit (200) are stacked on top of each other, thereby reducing the size of the imaging apparatus. Further, scanners disclosed in Japanese Unexamined Patent Application Publication No. 53-108728, Japanese Unexamined Utility Model Publication No. 54-184029, and Japanese Unexamined Patent Application Publication No. 59-201179 are known, though not relating to a biometric authentication apparatus.

A biometric authentication apparatus is incorporated not only in expensive equipment (e.g. an automated teller machine (ATM)) but also in relatively inexpensive electronic equipment (e.g. electronic equipment such as a cellular phone and a laptop computer (particularly, mobile communication equipment)). In the case of incorporating a biometric authentication apparatus into relatively inexpensive electronic equipment, it is important to reduce the unit price of the biometric authentication apparatus.

Further, in order to implement highly accurate biometric authentication, it is necessary to acquire biometric information in a desired range that is just enough. For accurate finger vein authentication, it is preferred to acquire a vein image in a region R100 of 15 mm in length and 20 mm in width as shown in FIG. 34, for example. However, if an area sensor that has a detection range corresponding to the region R100 is employed, the cost for sensor parts becomes high, causing an increase in the price of the biometric information acquisition apparatus as a whole.

If the cost for sensor parts is high, it is difficult to incorporate a biometric authentication apparatus into relatively inexpensive electronic equipment, which hinders the implementation of electronic equipment having the attractive function, i.e. vein authentication.

With use of an area sensor at a moderate price, it is possible to acquire a vein image in a narrower range (e.g. a region R101 of 10 mm in length and 15 mm in width (c.f. FIG. 34)) than the desired region R100. This case, however, fails to implement highly accurate vein authentication.

### SUMMARY OF THE INVENTION

The present invention has been accomplished to address the above concern, and an object of the present invention is thus to provide an apparatus that enables acquisition of an image in a desired range without significantly increasing the price of the apparatus.

According to an embodiment of the present invention, there is provided a biometric information acquisition apparatus including a sensor that includes at least one pixel row formed from a plurality of pixels, and a drive mechanism that moves the sensor in a direction intersecting a pixel arrangement direction of the pixel row.

In the above biometric information acquisition apparatus, the drive mechanism may move the sensor by extending or contracting a linear body based on electrical control.

In the above biometric information acquisition apparatus, the linear body comprises one of an organic polymer and a shape-memory alloy. Further, the linear body extends in a direction intersecting a moving direction of the sensor.

The above biometric information acquisition apparatus may further include a guide member that guides movement of the sensor, the guide member being attached to the sensor directly or indirectly.

The above biometric information acquisition apparatus may further include a regular pattern formed along a moving direction of the sensor. In this biometric information acquisition apparatus, the sensor may include a pixel to output a value corresponding to regularity of the pattern according to movement of the sensor.

The above biometric information acquisition apparatus may further include a detecting unit that detects the amount of the movement of the sensor, the sensor being controlled based on an output of the detecting unit.

The above biometric information acquisition apparatus may further include a connector that connects an output of the sensor to an external circuit, and a base member that is attached to the sensor directly or indirectly and comprises an opening to at least partly contain the connector.

The above biometric information acquisition apparatus may further include a light source that outputs light to be illuminated on a subject and moves with movement of the sensor. This biometric information acquisition apparatus may further include a plurality of light sources, and a light guide that guides output light from the plurality of light sources.

The above biometric information acquisition apparatus may further include a plurality of lenses, the sensor may be a photo sensor including a plurality of pixels corresponding to the plurality of lenses.

The above biometric information acquisition apparatus may further include a light source that outputs light to be illuminated on a subject, and a plurality of lenses, and the sensor may be a photo sensor including a pixel above which a lens included in the plurality of lenses is not placed.

According to another embodiment of the present invention, there is provided electronic equipment comprising the above biometric information acquisition apparatus.

According to another embodiment of the present invention, there is provided an image acquisition apparatus including a sensor that includes at least one pixel row formed from a plurality of pixels, a linear body that is coupled to the sensor directly or indirectly, and a drive mechanism that moves the sensor in a direction intersecting a pixel arrangement direction of the pixel row by extending or contracting the linear body based on electrical control. In this biometric information acquisition apparatus, the linear body extends in a direction intersecting a moving direction of the sensor.

According to another embodiment of the present invention, there is provided a biometric information acquisition apparatus including a plurality of lenses, a photo sensor that includes a pixel row formed from a plurality of first pixels above which the lenses are placed, and at least one second pixel above which the lenses are not placed, and a drive mechanism that moves the photo sensor in a direction intersecting a pixel arrangement direction of the pixel row.

According to another embodiment of the present invention, there is provided a biometric information acquisition apparatus including a plurality of lenses, and a photo sensor, the photo sensor including: a plurality of first pixels that receive light input respectively through the plurality of lenses, and a second pixel that receives light input not through a lens included in the plurality of lenses.

The above biometric information acquisition apparatus may further include a drive mechanism that moves the photo sensor in a direction intersecting a pixel arrangement direction of the plurality of first pixels.

In the above biometric information acquisition apparatus, at least two pixels of the plurality of first pixels are arranged to receive light input through a common lens of the plurality of lenses.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic diagram showing a cellular phone according to a first embodiment of the present invention;

FIG. 2 is a schematic diagram showing the structure of the front face of the cellular phone according to the first embodiment of the present invention;

FIG. 3 is a schematic diagram showing the structure of the top face of a biometric information acquisition apparatus according to the first embodiment of the present invention;

FIG. 4 is a schematic diagram showing the structure of the top face of the biometric information acquisition apparatus after movement according to the first embodiment of the present invention;

FIG. 5 is a schematic diagram showing the structure of a base portion of the biometric information acquisition apparatus according to the first embodiment of the present invention;

FIGS. 6A to 6D are schematic diagrams showing the structure of a carrier member and a container member included in the biometric information acquisition apparatus according to the first embodiment of the present invention;

FIGS. 7A and 7B are schematic diagrams showing the cross-sectional structure of the biometric information acquisition apparatus according to the first embodiment of the present invention;

FIG. 8 is a schematic diagram showing the cross-sectional structure of a photo detector according to the first embodiment of the present invention;

FIG. 9 is a schematic diagram showing the positional relationship of lenses and pixels according to the first embodiment of the present invention;

FIGS. 10A to 10C are schematic explanatory views to describe a pattern formed on a cover plate according to the first embodiment of the present invention;

FIG. 11 is an explanatory view to describe the positional relationship of a pixel row and a pattern according to the first embodiment of the present invention;

FIG. 12 is a block diagram showing the schematic structure of a signal processing unit connected to a photo sensor according to the first embodiment of the present invention;

FIG. 13 is a timing chart to describe the operation of the signal processing unit according to the first embodiment of the present invention;

FIG. 14 is a block diagram showing the schematic structure of a biometric authentication apparatus according to the first embodiment of the present invention;

FIG. 15 is a flowchart to describe the schematic operation of the biometric authentication apparatus according to the first embodiment of the present invention;

FIGS. 16A and 16B are explanatory views showing the schematic structure of an illuminator according to a second embodiment of the present invention;

FIGS. 17A and 17B are schematic diagrams to describe variations of the illuminator according to the second embodiment of the present invention;

FIG. 18 is a schematic explanatory view showing the relationship of a pattern 14 and a pixel row according to a third embodiment of the present invention;

FIG. 19 is a schematic diagram showing the structure of the top face of a biometric information acquisition apparatus 71 according to a fourth embodiment of the present invention;

FIG. 20 is a schematic diagram showing the structure of the top face of a biometric information acquisition apparatus 72 according to a fifth embodiment of the present invention;

FIGS. 21A and 21B are explanatory views showing the positional relationship of members included in a biometric information acquisition apparatus according to a sixth embodiment of the present invention;

FIG. 22 is an explanatory view showing the relationship of a photo sensor, a lens and a pattern according to a seventh embodiment of the present invention;

FIG. 23 is a schematic diagram showing the structure of a biometric information acquisition apparatus before a photo sensor moves according to an eighth embodiment of the present invention;

FIG. 24 is a schematic diagram showing the structure of the biometric information acquisition apparatus after the photo sensor has moved according to the eighth embodiment of the present invention;

FIG. 25 is a graph showing the characteristics of a spring according to the eighth embodiment of the present invention;

FIGS. 26A and 26B are explanatory views to describe the extension and contraction of the spring according to the eighth embodiment of the present invention;

FIGS. 27A to 27C are explanatory views showing variations of placement of the spring according to the eighth embodiment of the present invention;

FIG. 28 is a schematic diagram showing the sectional structure of a photo sensor according to a ninth embodiment of the present invention;

FIGS. 29A and 29B are schematic explanatory views to describe a pattern formed on a cover plate according to the ninth embodiment of the present invention;

FIGS. 30A and 30B are schematic explanatory views to describe a laminated structure of the pattern according to the ninth embodiment of the present invention;

FIGS. 31A and 31B are explanatory views to describe the positional relationship of elements included in a biometric information acquisition apparatus according to the ninth embodiment of the present invention;

FIG. 32 is a block diagram showing the schematic structure of a signal processing unit connected to a line sensor according to the ninth embodiment of the present invention;

FIG. 33 is a timing chart to describe the operation of the signal processing unit according to the ninth embodiment of the present invention; and

FIG. 34 is an explanatory view to describe a desired range.

### DESCRIPTION OF THE PREFERRED EMBODIMENTS

### First Embodiment

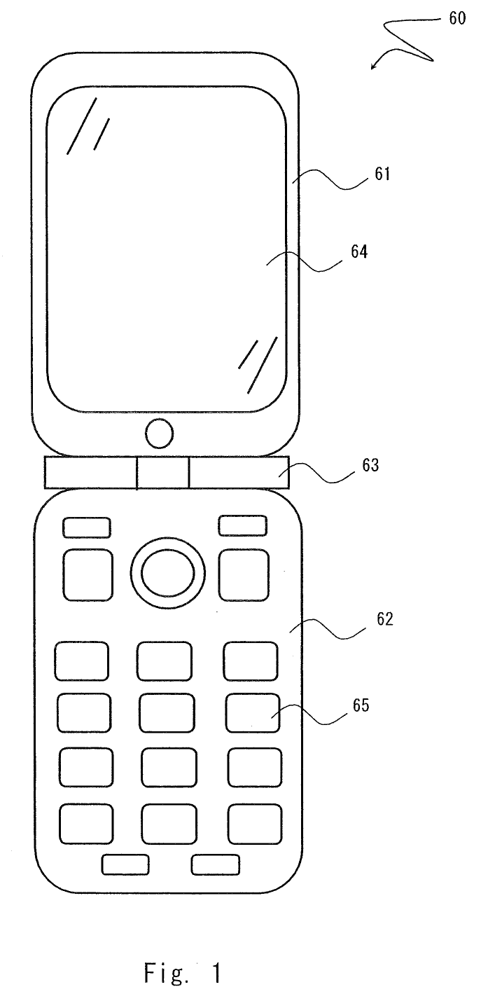

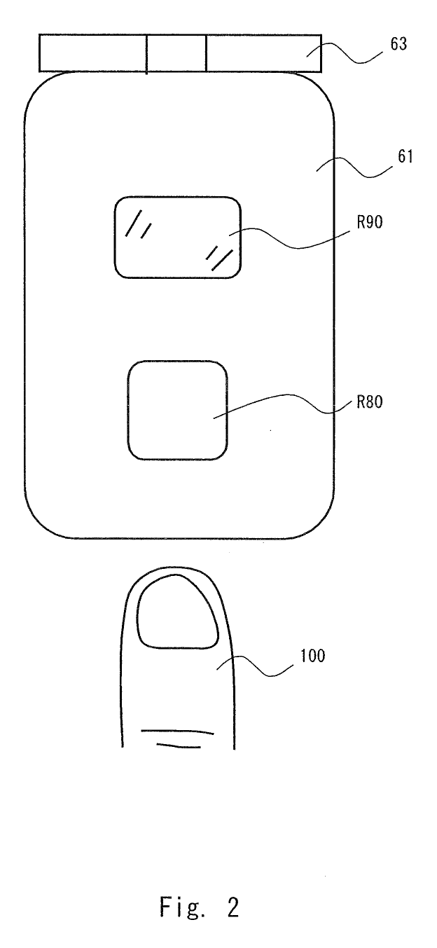

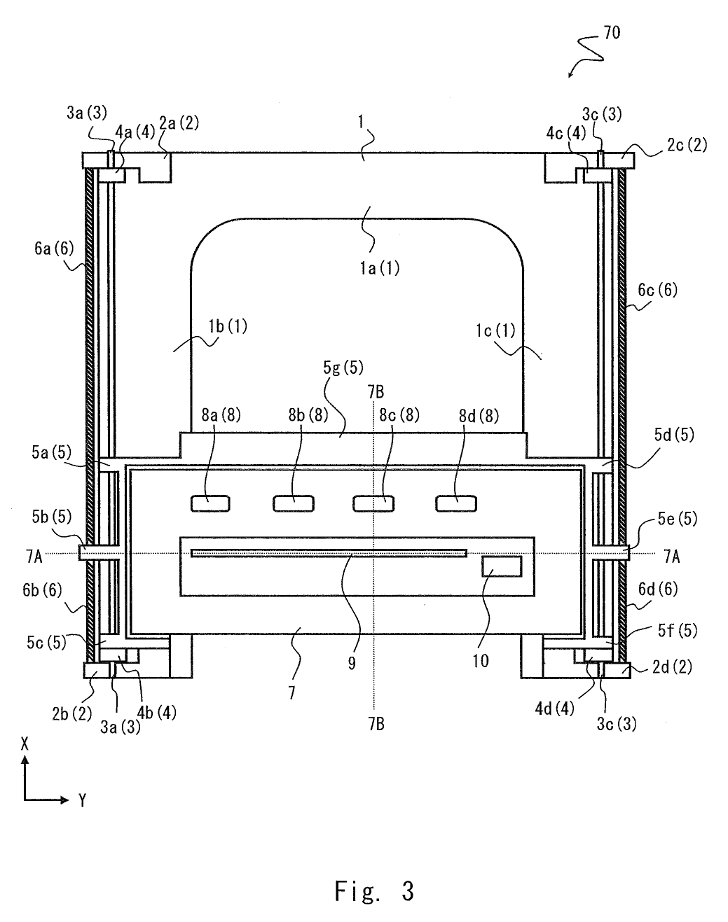

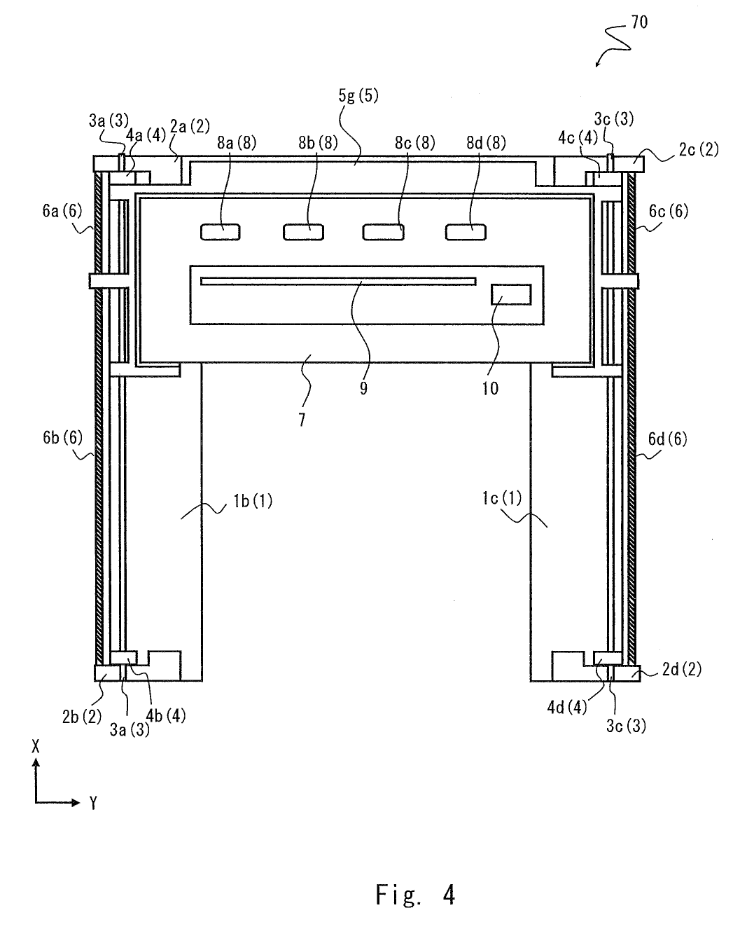

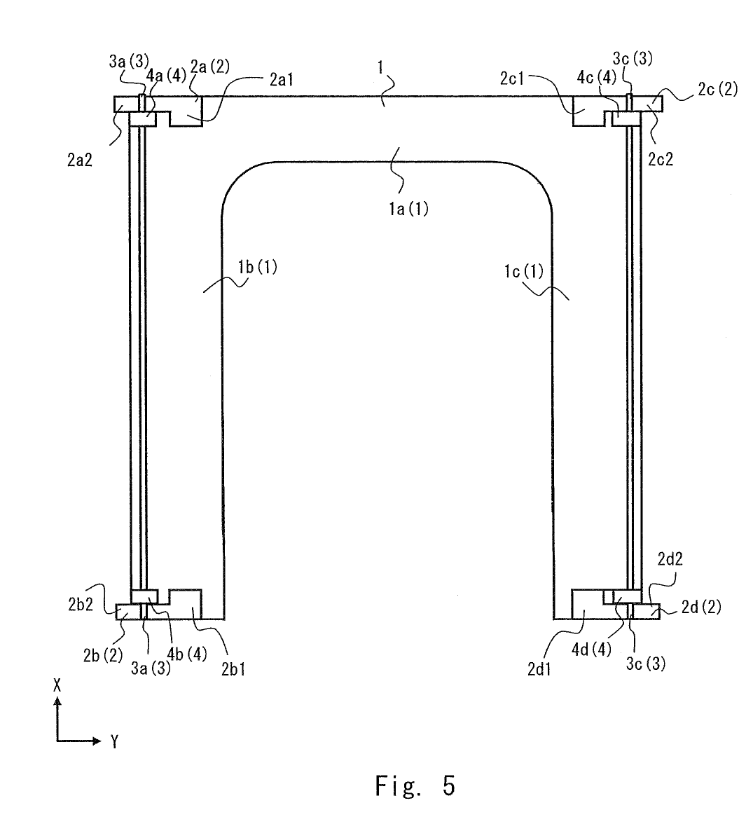

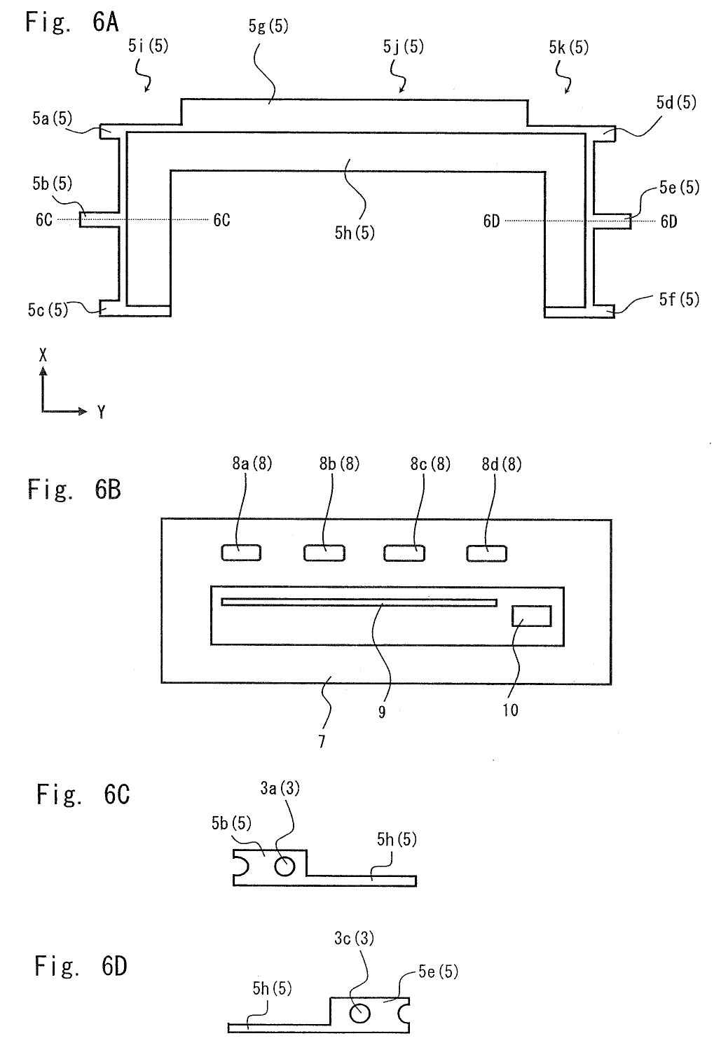

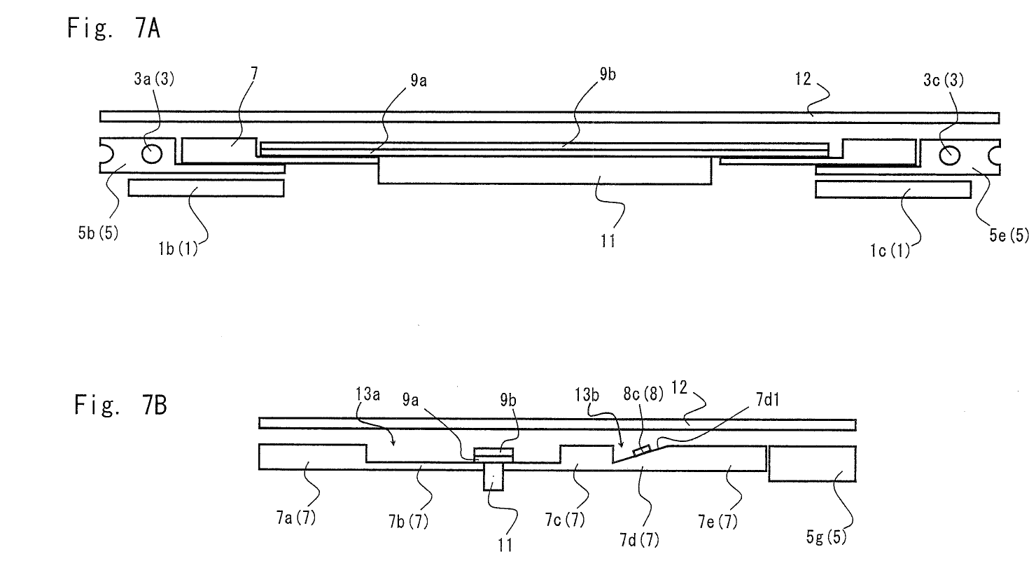

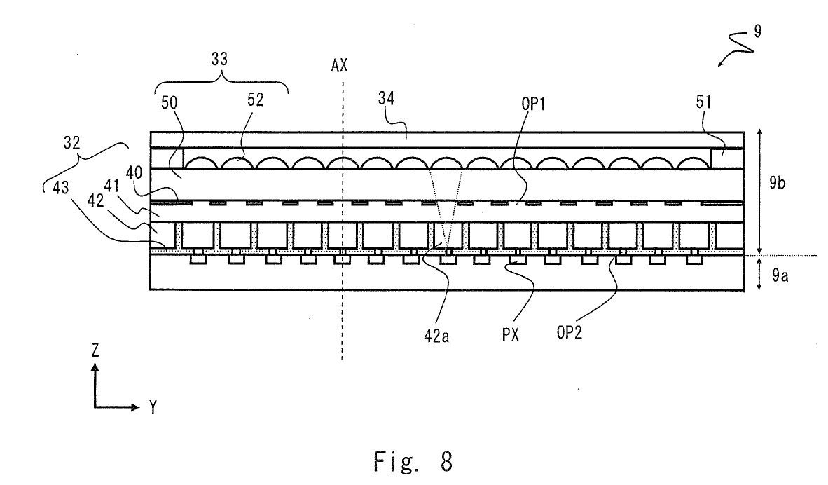

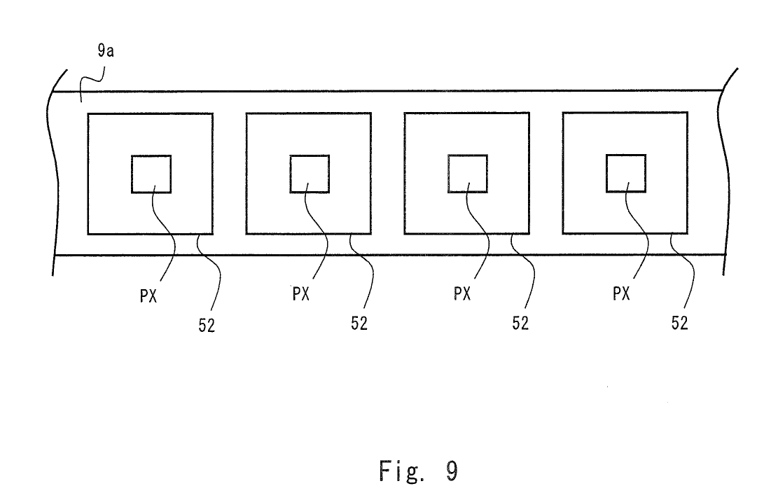

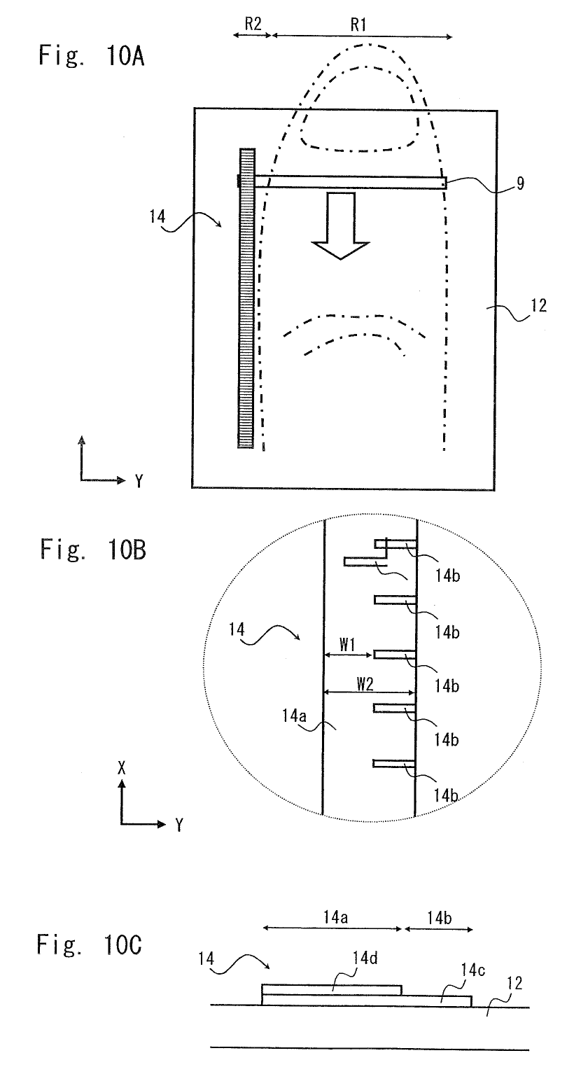

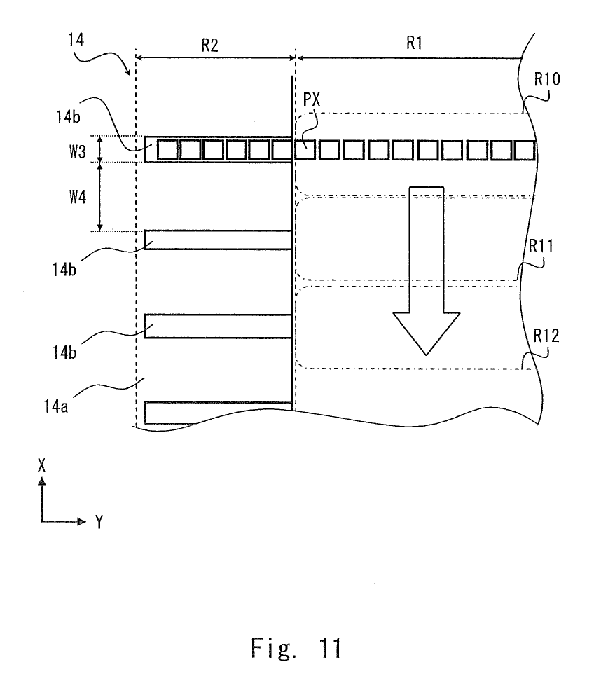

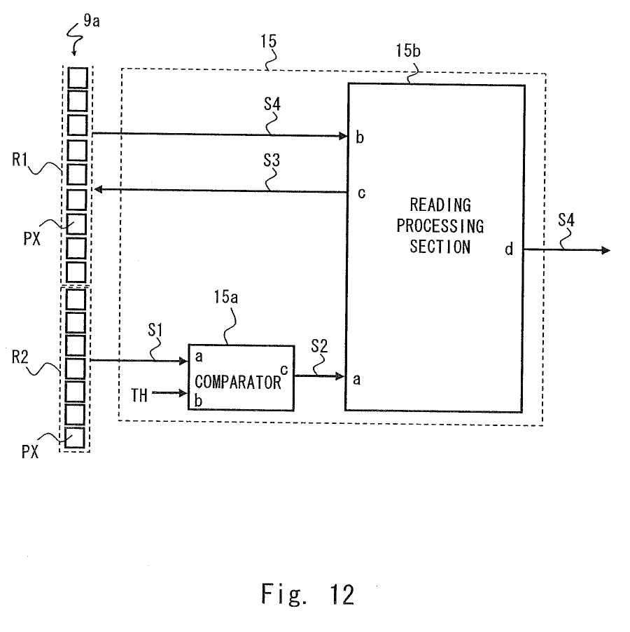

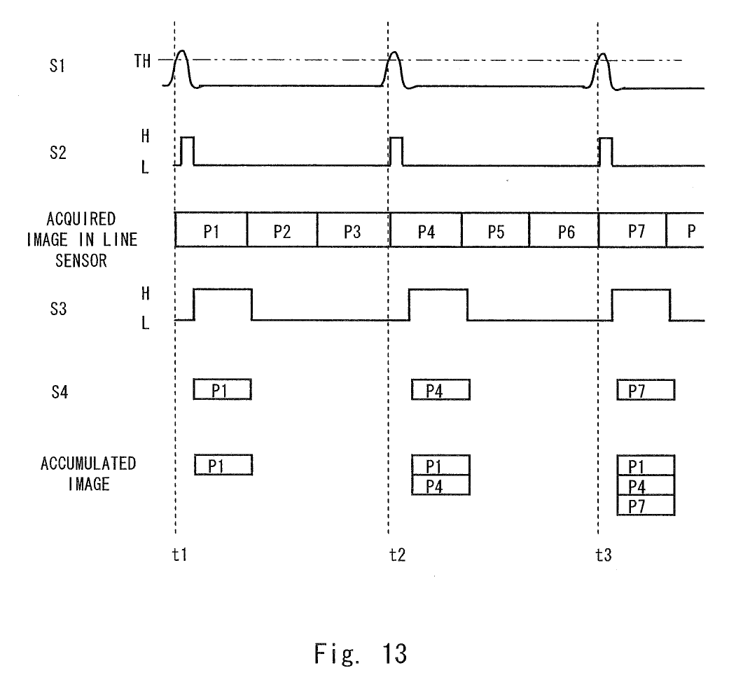

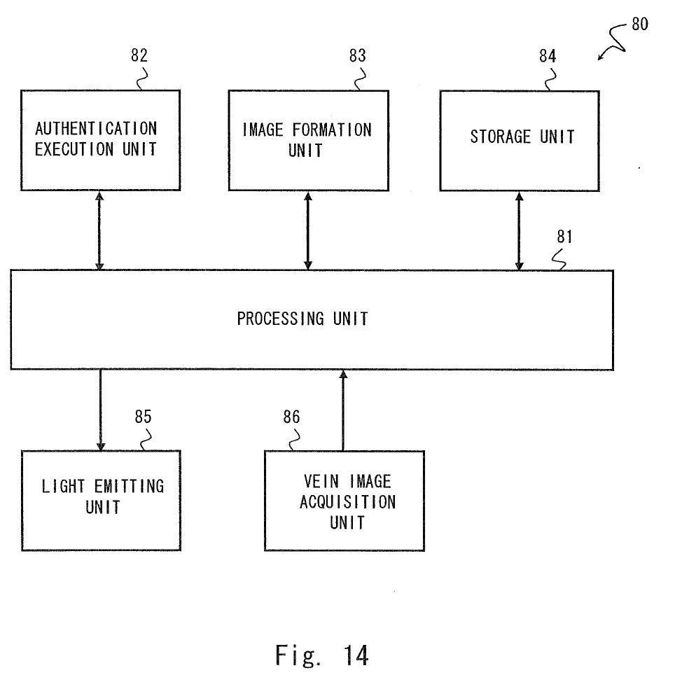

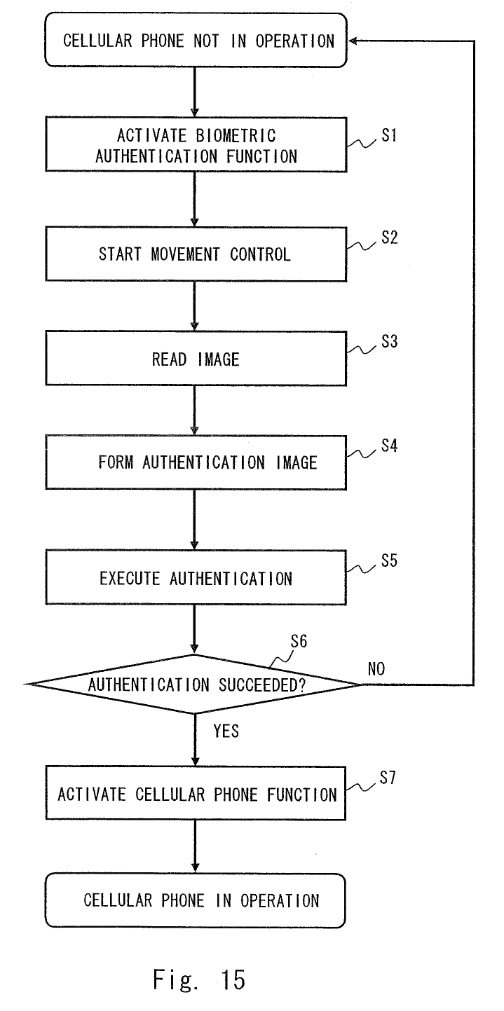

A first embodiment of the present invention is described hereinafter with reference to FIGS. 1 to 14. FIG. 1 is a schematic diagram of a cellular phone. FIG. 2 is a schematic diagram showing the structure of the front face of the cellular phone. FIG. 3 is a schematic diagram showing the structure of the top face of a biometric information acquisition apparatus. FIG. 4 is a schematic diagram showing the structure of the top face of the biometric information acquisition apparatus after movement. FIG. 5 is a schematic diagram showing the structure of a base portion of the biometric information acquisition apparatus. FIGS. 6A to 6D are diagrams showing the schematic structure of a carrier member and a container member included in the biometric information acquisition apparatus. FIGS. 7A and 7B are diagrams showing the schematic cross-sectional structure of the biometric information acquisition apparatus. FIG. 8 is a diagram showing the schematic cross-sectional structure of a photo detector. FIG. 9 is a schematic diagram showing the positional relationship of lenses and pixels. FIGS. 10A to 10C are schematic explanatory views to describe a pattern formed on a cover plate. FIG. 11 is an explanatory view to describe the positional relationship of a pixel row and a pattern. FIG. 12 is a block diagram showing the schematic structure of a signal processing unit connected to a photo sensor. FIG. 13 is a timing chart to describe the operation of the signal processing section. FIG. 14 is a block diagram showing the schematic structure of a biometric authentication apparatus. FIG. 15 is a flowchart to describe the schematic operation of the biometric authentication apparatus.

FIG. 1 shows a cellular phone (mobile communication terminal) 60. The cellular phone 60 incorporates a biometric authentication apparatus (vein authentication apparatus) 80, which is described later.

Referring to FIG. 1, the cellular phone 60 includes an upper body (first member) 61, a lower body (second member) 62, and a hinge 63. The upper body 61 and the lower body 62 are flat-shaped members made of plastic, and they are joined via the hinge 63. The upper body 61 and the lower body 62 can be freely opened and closed by the hinge 63. When the upper body 61 and the lower body 62 are in the closed state, the cellular phone 60 is in the form of a flat-shaped member in which the upper body 61 and the lower body 62 are placed on top of one another.

The upper body 61 includes a display section 64 on the inner face. Information that identifies a caller (name and phone number), an address book stored in a storage unit of the cellular phone 60 and so on are displayed on the display section 64. A liquid crystal display device is incorporated below the display section 64.

The lower body 62 includes a plurality of buttons 65 on the inner face. A user of the cellular phone 60 opens the address book, makes a phone call, or sets the manner mode on, for example, by operating the buttons 65, thereby operating the cellular phone 60 as intended. Further, the user of the cellular phone 60 turns on or off the biometric authentication function of the biometric authentication apparatus 80 inside the cellular phone 60 by operating the buttons 65.

FIG. 2 shows the structure of the front face (top face) of the cellular phone 60. A display region R80 and a display region R90 are placed on the front face of the upper body 61.

A finger 100 of human (subject) is placed on the display region R80 as schematically shown in FIG. 2. A biometric information acquisition apparatus 70 (cf. FIG. 3), which is described later, is incorporated below the display region R80. Characters (time, operating state, caller name etc.) are displayed on the display region R90. A liquid crystal display device is incorporated below the display region R90.

FIGS. 3 and 4 are schematic diagrams showing the structure of the top face of the biometric information acquisition apparatus 70. FIG. 3 shows the state before the movement of the photo sensor included in a light detecting module 9. FIG. 4 shows the state after the movement of the photo sensor included in the light detecting module 9. FIG. 5 shows a partial structure of the biometric information acquisition apparatus. FIGS. 6A to 6D show the schematic structure of the top face of a carrier member and a container member included in the biometric information acquisition apparatus. In those drawings, axis lines such as an x-axis, a y-axis and a z-axis are set according to need.

Referring to FIG. 3, the biometric information acquisition apparatus 70 includes a base plate (base member) 1, a carrier member 5, and a container member 7. The base plate 1, the carrier member 5 and the container member 7 are made of a resin material. Further, the biometric information acquisition apparatus 70 includes a rail (guide member) 3, a cushioning member 4, a spring 6, a light emitting device (light source) 8, a light detecting module 9, and an A-D converter 10. The light detecting module 9 includes a photo sensor 9a (cf. FIG. 7). The biometric information acquisition apparatus 70 further includes a cover plate 12 (cf. FIG. 7). As obvious from the description below, a drive mechanism according to this embodiment includes the spring 6, which is described in detail later.

Refer first to FIG. 5. As shown in FIG. 5, the base plate 1 is a plate member that is substantially “U” shaped when viewed from above, and it includes a coupling portion 1a, a left flat plate portion 1b, and a right flat plate portion 1c. The base plate 1 is fixed to a substrate inside a housing of the cellular phone 60 by a fixing means such as a screw or an adhesive.

The left flat plate portion 1b and the right flat plate portion 1c extend in parallel with each other along the x-axis. The coupling portion 1a extends along the y-axis that is perpendicular to the x-axis. The left flat plate portion 1b and the right flat plate portion 1c are coupled at the upper part by the coupling portion 1a. An opening exists between the left flat plate portion 1b and the right flat plate portion 1c. A connector 11 (cf. FIG. 7) is partly placed in the opening.

The base plate 1 includes four support portions 2 (2a to 2d) at the four corners. The support portion 2a is placed at the upper end of the left flat plate portion 1b. The support portion 2b is placed at the lower end of the left flat plate portion 1b. The support portion 2c is placed at the upper end of the right flat plate portion 1c. The support portion 2d is placed at the lower end of the right flat plate portion 1c. The support portions 2a to 2d are formed integrally with base plate 1. Alternatively, the support portions 2a to 2d and the base plate 1 may be separate members, and the support portions 2a to 2d may be fixed to the base plate 1.

The support portion 2a includes a wide portion 2a1 and a narrow portion 2a2. The wide portion 2a1 is located inner than the narrow portion 2a2, and it has a larger width along the x-axis than the narrow portion 2a2. The description about the support portion 2a holds true for the other support portions 2b to 2d, and the redundant description will be omitted.

The rail 3 is mechanically held between the opposite support portions 2. The rail 3 is made of a stick-like metal, and it guides the movement of the carrier member 5. Lubricating oil may be applied to the rail 3 in order to make the movement of the carrier member 5 smooth.

The rail 3a is placed between the opposite support portions 2a and 2b. The upper end of the rail 3a is fixed to the support portion 2a, and the lower end of the rail 3a is fixed to the support portion 2b. The rail 3c is placed between the opposite support portions 2c and 2d. The upper end of the rail 3c is fixed to the support portion 2c, and the lower end of the rail 3c is fixed to the support portion 2d.

The cushioning member 4a is placed on the inner surface of the narrow portion 2a2 of the support portion 2a. The cushioning member 4a is made of an elastic material such as rubber and sponge. The inner surface of the cushioning member 4a is contactable with the side surface of the carrier member 5, thereby absorbing the shock given to the wide portion 2a1 by the moving carrier member 5. With the cushioning member 4a functioning as a shock absorbing member, it is possible to stop the movement of the carrier member 5 in a more mechanically and structurally stable manner. The description holds true for the other cushioning members 4b to 4d and the wide portions 2b to 2d.

Referring then to FIGS. 6A to 6D, as shown in FIG. 6A, the carrier member 5 is a member that is substantially “U” shaped when viewed from above, and it includes a left portion 5i, a middle portion 5j, and a right portion 5k. The left portion 5i and the right portion 5k extend substantially in parallel with each other along the x-axis. The middle portion 5j extends along the y-axis and couples the left portion 5i and the right portion 5k at the upper part.

The carrier member 5 includes thick plate portions 5a to 5g and a thin plate portion 5h. The container member 7 (cf. FIG. 6B) is placed in the space surrounded by the thick plate portions 5a to 5g. The lower surface of the container member 7 is adhered to the upper surface of the thin plate portion 5h by an adhesive. The container member 7 is thereby fixed inside the carrier member 5.

FIG. 6C shows the cross-sectional structure of the carrier member 5 along line 6C-6C in FIG. 6A.

As shown in FIG. 6C, the thick plate portion 5b of the carrier member 5 has a hole through which the rail 3a passes, and the rail 3a is inserted into the hole. When the rail 3a is inserted into the hole of the thick plate portion 5b, a space that allows the carrier member 5 to move along the rail 3a is maintained. Further, the thick plate portion 5b of the carrier member 5 has a hole for partly containing the spring 6 on its outer side.

FIG. 6D shows the cross-sectional structure of the carrier member 5 along line 6D-6D in FIG. 6A. As shown in FIG. 6D, the thick plate portion 5e of the carrier member 5 has a hole through which the rail 3c passes, and the rail 3c is inserted into the hole. In this case also, an allowance space is maintained as in the description of FIG. 6C. Further, the thick plate portion 5e of the carrier member 5 has a hole for partly containing the spring 6 on its outer side.

The inner end of each spring 6 is attached to the thick plate portions 5b and 5e. Thus, the thick plate portions 5b and 5e protrude more than the thick plate portions 5a, 5c, 5d and 5f. Each of the thick plate portions 5a, 5c, 5d and 5f also has a hole through which the rail 3 passes.

Refer now back to FIG. 3.

As shown in FIG. 3, the outer end (upper end) of the spring 6a is fixed to the support portion 2a, and the inner end (lower end) of the spring 6a is fixed to the thick plate portion 5b of the carrier member 5. The outer end (lower end) of the spring 6b is fixed to the support portion 2b, and the inner end (upper end) of the spring 6b is fixed to the thick plate portion 5b of the carrier member 5. The outer end (upper end) of the spring 6c is fixed to the support portion 2c, and the inner end (lower end) of the spring 6c is fixed to the thick plate portion 5e of the carrier member 5. The outer end (lower end) of the spring 6d is fixed to the support portion 2d, and the inner end (upper end) of the spring 6d is fixed to the thick plate portion 5e of the carrier member 5. The way of attaching a coil is arbitrary. For example, the tip of the coil may be shaped like a hook, and it may be hooked on the thick plate portion or the support portion.

In this embodiment, the springs 6a and 6c are coil members formed by winding a linear Ti—Ni or Ti—Ni—Cu alloy (shape-memory alloy) into a coil. Further, in this embodiment, pulse-modulated current is applied to the springs 6a and 6c. The springs 6a and 6c function as resistors, and they generate heat according to the amount of current flowing therethrough. If the temperatures of the springs 6a and 6c become higher than a prescribed level, the springs 6a and 6c contract.

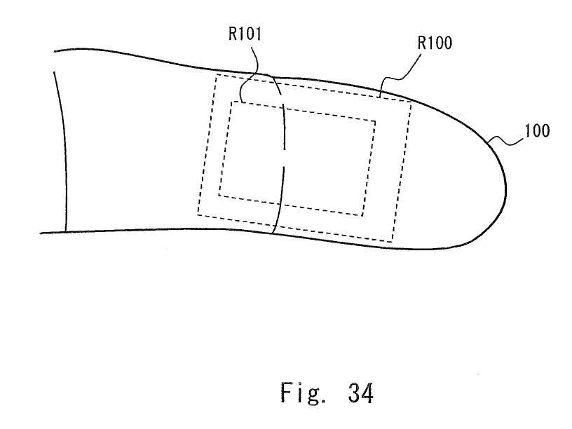

The carrier member 5 thereby moves from the lower to the upper position as shown in FIGS. 3 and 4. On the carrier member 5, a photo sensor 9a is mounted with the container member 7 placed therebetween. As the carrier member 5 moves, the photo sensor 9a moves accordingly. The photo sensor 9a sequentially acquires images throughout the moving period of the carrier member 5, thereby acquiring images within a range corresponding to the moving range of the photo sensor 9a. In this embodiment, the photo sensor 9a is controlled to move corresponding to the desired range R100 shown in FIG. 34. It is thereby possible to acquire a vein image in the desired region R100 that is necessary for implementing highly accurate vein authentication with use of the photo sensor having a small number of pixel rows.

The springs 6b and 6d are general helical springs formed by winding a metal wire. Thus, when pulse current is not applied to the springs 6a and 6c, the carrier member 5 is in the position shown in FIG. 3 due to the tensile force of the springs 6b and 6d. Specifically, in normal times, the carrier member 5 is located near the support portions 2b and 2d to which the springs 6b and 6d are fixed. In biometric information acquisition times, the carrier member 5 moves from near the support portions 2b and 2d to near the support portions 2a and 2c by the application of pulse current to the springs 6a and 6c.

The tensile force of the springs 6a and 6c caused by the application of pulse current is sufficiently larger than the tensile force of the springs 6b and 6d. Accordingly, it is possible to move the carrier member 5 from the position of FIG. 3 to the position of FIG. 4 in a relatively short time. The tensile force is increased by winding a shape-memory alloy wire into a coil.

In this manner, because the carrier member 5 can be moved simply by applying pulse current to the springs 6a and 6c, it offers advantages of not generating noise, not generating vibration, reducing current consumption and so on compared with other drive mechanisms (e.g. a drive mechanism using a motor).

The current applied to the springs 6a and 6c may be direct current or simple alternating current. By applying pulse-modulated current to the springs 6a and 6c, it is possible to adjust the amount of current flowing therethrough with relatively high accuracy.

When returning to the state of FIG. 3 from the state of FIG. 4, supply of pulse current to the springs 6a and 6c is stopped. Then, the carrier member 5 moves from the position of FIG. 4 to the position of FIG. 3 by itself due to the tensile force of the springs 6b and 6d. The springs 6a and 6c do not exert the effective spring function unless they are heated.

As shown in FIG. 3, the light emitting device 8, the light detecting module 9 and the A-D converter 10 are contained in the container member 7.

The light emitting device 8 is a semiconductor light emitting device fabricated by molding a semiconductor bare chip such as a semiconductor light emitting diode (LED) or a semiconductor laser diode (LD) into package. The light emitting device 8 outputs light with a wavelength in the near infrared region (which is a wavelength of 600 nm to 1000 nm, and it is 760 nm or 870 nm in this example) by applying current between electrodes.

The light detecting module 9 is an optical element in which an optical functional portion 9b is placed on top of the photo sensor 9a, as described later. The light detecting module 9 is composed of the photo sensor 9a, the optical functional portion 9b and the connector 11. The photo sensor 9a is a photo sensor in which pixels including photo diodes are arranged in one row. The optical functional portion 9b has one lens row corresponding one pixel row. Further, the optical functional portion 9b has a light shielding structure that separates each optical channel between the lens and the pixel. A specific structure of the light detecting module 9 is described later with reference to FIG. 8.

The A-D converter (semiconductor integrated circuit) 10 is a semiconductor circuit that converts an analog signal output from each pixel of the photo sensor 9a into a digital signal through a transimpedance circuit. Another function may be added in addition to the A-D conversion function.

The inside structure of the container member 7 is described hereinafter with reference to FIGS. 7A and 7B. FIG. 7A is a diagram showing the schematic cross-sectional structure of the biometric information acquisition apparatus 70 along line 7A-7A in FIG. 3. FIG. 7B is a diagram showing the schematic cross-sectional structure of the biometric information acquisition apparatus 70 along line X1-X1 in FIG. 3.

As shown in FIG. 7A, the container member 7 is fixed inside the recessed portion of the carrier member 5. The container member 7 has a recessed portion for containing the light detecting module 9.

The cover plate 12 is placed above the carrier member 5 and so on. The cover plate 12 is a transparent plate member such as transparent resin or glass, and it protects the biometric information acquisition apparatus 70 from the outside. The cover plate 12 is substantially transparent to output light from the light emitting device 8. The way of placing the cover plate 12 is arbitrary. For example, the cover plate 12 may be fixed to the base plate 1 by fixing the cover plate 12 to the upper surfaces of the support portions 2a to 2d.

Because the carrier member 5 is supported by the rail 3, a prescribed space exists between the carrier member 5 and the base plate 1.

As shown in FIG. 7B, the container member 7 has a thick portion 7, a thin portion 7b, a thick portion 7c, a sloping portion 7d, and a thick portion 7e sequentially in this order. The sloping portion 7d is a part that gradually increases in thickness from the thick portion 7c to the thick portion 7e, and it has a sloping surface 7d1 between the thick portion 7c and the thick portion 7e. Because of the thin portion 7b existing between the thick portions, a recessed portion (container space) 13a is formed in the container member 7. Further, because of the sloping portion 7d existing between the thick portions, a recessed portion (container portion) 13b is formed in the container member 7.

The light detecting module 9 is placed on the bottom surface of the recessed portion 13a (i.e. the upper surface of the thin portion 7b). The light emitting device 8 is placed on the bottom surface of the recessed portion 13b (i.e. the upper surface of the sloping portion 7d). In this embodiment, the light emitting device 8 and the light detecting module 9 move together according to the movement of the carrier member 5. This enables the amount of light input to the photo sensor 9a to be a desired range regardless of the position of the photo sensor 9a compared with the case where the light emitting device 8 is fixed to the outside of the carrier member.

The connector 11 is attached to a hole of the thin portion 7b. The connector 11 is connected to an external semiconductor circuit via a flexible wiring board. By the thick portion 7c placed between the light emitting device 8 and the photo sensor 9a, it is possible to prevent the output light from the light emitting device 8 from directly entering the photo sensor 9a.

Further, in this embodiment, the light emitting device 8 is placed on the upper surface of the sloping portion 7d. This allows the output light of the light emitting device 8 to be in the oblique direction. It is thereby possible to illuminate the finger 100 with a near infrared ray more effectively. By designing the shape of a base on which the light emitting device 8 is placed as appropriate, it is possible to implement control of the direction of output light very easily. Current is supplied to the light emitting device 8 through a flexible wiring board (film wiring). This is the same for the photo sensor 9a.

FIG. 8 shows the schematic cross-sectional structure of the light detecting module 9. As shown in FIG. 8, the light detecting module 9 is an optical element in which the optical functional portion 9b is placed on top of the photo sensor 9a.

As shown in FIG. 8, the photo sensor 9a includes one pixel row in which a plurality of pixels PX are sequentially arranged at prescribed intervals. In the optical functional portion 9b, an optical channel separation layer 32, a microlens array 33 and a bandpass filter 34 are arranged in this order from below to above. The connector 11 is connected to the photo sensor 9a.

The bandpass filter (filter member) 34 is a plate optical member that selectively transmits a near infrared band (650 nm to 1000 nm; preferably 650 nm to 800 nm) in which output light (which is also referred to hereinafter as inspection light) from the light emitting device 8 is included.

The microlens array 33 includes a transparent substrate 50 and lenses (condenser lenses) 52. Further, a spacer layer 51 that supports the bandpass filter 34 is placed on the upper surface of the transparent substrate 50.

The plurality of lenses 52 are arranged in a line, respectively corresponding to the pixels PX of the photo sensor 9a (cf. FIG. 9). The pixel PX is placed on the optical axis of the lens 52. The lens 52 is rectangular when viewed from above. The thickness of field of the lens 52 is 4 mm or shallower. The thickness of the lens 52 is 3 to 5 mm.

The transparent substrate 50 and the lens 52 are made of a material that is substantially transparent to the inspection light. The transparent substrate 50 is a quartz substrate. The lens 52 is an optical element that is formed by partially removing a resist layer deposited on the transparent substrate 50 by photolithography using a grayscale mask. By placing the microlens array 33 above the pixel PX, it is possible to suitably capture a vein image located at a certain depth below the skin of the finger 100.

The optical channel separation layer 32 includes a light shielding film 40, a first transparent layer 41, a second transparent layer 42 and a resist layer 43.

The light shielding film 40 is a layer in which a metal material is formed like a lattice on the lower surface of the microlens array 33 using normal semiconductor process technology (e.g. sputtering, deposition, etc.) The light shielding film 40 has a plurality of openings OP1 that are formed in a matrix corresponding respectively to the lenses 52 of the microlens array 33. The plurality of openings OP1 indicate openings in optical terms. In this case, the openings OP1 are filled with the first transparent layer 41, but should not limited to.

The first transparent layer 41 is a layer that is made of resist (resin material), and it is substantially transparent to the inspection light. The first transparent layer 41 is formed on the lower surface of the microlens array 33 by normal coating technique (e.g. spin coating) after the light shielding film 40 is formed. The viscosity of the first transparent layer 41 is lost by heat treatment after coating.

The second transparent layer 42 is a resist layer that is made of the same material as the first transparent layer 41. Thus, the second transparent layer 42 is also substantially transparent to the inspection light. The second transparent layer 42 has a plurality of lands 42a that are spaced from each another. The land 42a is formed by creating lattice-like grooves in the second transparent layer 42 after the second transparent layer 42 is formed on the lower surface of the first transparent layer 41 by normal coating technique (e.g. spin coating). Thus, the plurality of lands 42a that are separated from each another are formed by creating the lattice-like grooves. The separated lands 42a are arranged two dimensionally corresponding respectively to the pixels PX of the photo sensor 9a. The lands indicate island parts that are defined by the grooves. The lands are not necessarily separated completely from each other.

The resist layer 43 is deposited so as to cover the lands 42a. The resist layer 43 contains a material that absorbs the inspection light (e.g. phthalocyanine). The resist layer 43 is formed by depositing a resist material so as to cover the lands 42a (i.e. to fill in the grooves of the second transparent layer 42) using spin coating or the like. Then, openings OP2 corresponding respectively to the focus positions of the lenses 52 of the microlens array 33 are created in the resist layer 43 using lithography. The openings OP2 also correspond to the positions of the pixels PX of the photo sensor 9a. The openings OP2 are arranged in a line corresponding to the pixels PX of the photo sensor 9a.

The function of the light detecting module 9 is described hereinafter. The inspection light that is reflected in the internal area of the finger 100 is focused on the pixel PX of the photo sensor 9a through the lens 52 of the microlens array 33. This is described hereinafter in detail in the order of events. The internal area is at a depth of about 1 mm below the surface of the finger 100.

The inspection light that is output from the light emitting device 8 is illuminated on the human finger 100. The inspection light is reflected inside the human finger 100. Further, the inspection light is absorbed by the vein inside the human finger 100.

The inspection light that has been transmitted through the human finger 100 is incident on the light detecting module 9. The inspection light first passes through the bandpass filter 34. Outside light different from the inspection light is blocked by the bandpass filter 34. Because the bandpass filter 34 blocks a noise component, it is possible to acquire a higher-quality image.

The inspection light that has passed through the bandpass filter 34 is incident on the microlens array 33. In the microlens array 33, the inspection light is focused on each pixel PX of the photo sensor 9a by each lens 52 arranged on the upper surface of the transparent substrate 50.

The light that has been focused by the lens 52 of the microlens array 33 is then incident on the optical channel separation layer 32. The optical channel separation layer 32 has the opening OP1 and the opening OP2 that are arranged in a line corresponding to each pixel of the photo sensor 9a. The optical channel separation layer 32 further includes the land 42a that is also arranged in a line corresponding to each pixel of the photo sensor 9a. The resist layer 43 is filled between the adjacent lands 42a. The resist layer 43 is also formed on the lower surfaces of the lands 42a. The resist layer 43 contains a pigment that absorbs a near infrared ray. Thus, the light incident on the resist layer 43 is effectively absorbed by the pigment contained in the resist layer 43.

In such a structure, the optical channel separation layer 32 separates optical paths (optical channels) from the lens 52 of the microlens array 33 to the pixel PX of the photo sensor 9a. This prevents cross talk that can occur between optical channels. Because the inspection light is condensed from the lens 52 toward the pixel PX, the width of the opening OP2 is set to be narrower than the width of the opening OP1.

The light incident on each pixel of the photo sensor 9a is photoelectrically converted in the pixel. It is then read as an electrical signal and further converted from analog to digital by the A-D converter 10.

Referring then to FIGS. 10A to 13, a pattern formed on the back surface of the cover plate 12 and operation of reading an image signal from the photo sensor 9a using the pattern are described hereinbelow. FIG. 10A is a schematic diagram showing the structure of the pattern that is formed on the cover plate 12. FIG. 10B is a partially enlarged schematic view of the pattern. FIG. 10C is a schematic view showing the laminated structure of the pattern.

As shown in FIG. 10A, a regular pattern 14 is formed on the back surface of the cover plate 12.

As shown in FIG. 10B, the pattern 14 includes a light absorbing portion 14a and light reflecting portions 14b. The light absorbing portion 14a absorbs a near infrared ray that is output from the light emitting device 8. The light reflecting portions 14b reflect a near infrared ray that is output from the light emitting device 8.

The light absorbing portion 14a is a linear portion having a part with a width of W1 and a part with a width of W2 (W1<W2). The light reflecting portions 14b are arranged at regular intervals.

As shown in FIG. 10C, the pattern 14 is a lamination in which a black resin layer 14d is formed on top of a metal layer 14c. The metal layer 14c is formed on the back surface of the cover plate 12. The pattern 14 is formed using normal thin film formation technique and patterning technique.

As shown in FIG. 10B, by regularly patterning the black resin layer 14d, the metal layer 14c is partly exposed, so that the light reflecting portions 14b are formed regularly. The light absorbing portion 14a is a part where the patterned black resin layer 14d is not removed.

FIG. 11 shows the relationship of the pixel row of the photo sensor 9a and the pattern 14. The pixel row is formed across a region R1 where the pattern 14 is not formed and a region R2 where the pattern 14 is formed. The pixel row is placed in parallel with the longitudinal direction of the light reflecting portion 14b.

When the pixel row moves as indicated by the arrow of FIG. 11, the pixel PX in the region R2 passes the light absorbing portion 14a and the light reflecting portion 14b alternately. During the moving period of the photo sensor 9a, the light emitting device 8 emits light. Thus, as the pixel PX in the region R2 comes closer to the light reflecting portion 14b, an output value from the pixel PX in the region R2 increases. The light reflecting portions 14b are arranged regularly at prescribed intervals. Therefore, the amount of movement of the photo sensor 9a can be detected based on the output from the pixel PX in the region R2. As a result, it is possible to output an image from the photo sensor 9a at an appropriate timing, as described later.

In this example, a width W3 along the x-axis of the light absorbing portion 14a is set to be substantially N times a width W4 along the x-axis of the light reflecting portions 14b (N is a natural number of 2 or above).

FIG. 12 shows the schematic structure of a signal processing unit that is connected to the photo sensor 9a. As shown in FIG. 12, a signal processing unit 15 includes a comparator 15a and a reading processing section 15b. The A-D converter 10 is not shown for convenience of description.

The signal processing unit 15 has a following connection relationship. An output from the pixel in the region R2 is connected to an input a of the comparator 15a. A threshold is input to an input b of the comparator 15a. An output c of the comparator 15a is connected to an input a of the reading processing section 15b. An output from the pixel in the region R1 is connected to an input b of the reading processing section 15b. An output c of the reading processing section 15b is connected to the photo sensor 9a. An output d of the reading processing section 15b is connected to an external control circuit.

The comparator 15a compares a signal S1 that is output from the pixel in the region R2 with a predetermined threshold TH. If the signal S1 exceeds the threshold TH, the comparator 15a outputs a high level signal (timing detection signal) S2.

When the high level signal S2 is supplied from the comparator 15a, the reading processing section 15b outputs a high level signal (read instruction signal) S3 to the photo sensor 9a.

The photo sensor 9a executes image acquisition at prescribed cycles. When the high level signal S3 is supplied from the reading processing section 15b, the photo sensor 9a outputs a signal S4 that is accumulated at that time to the input b of the reading processing section 15b. The reading processing section 15b outputs the signal S4 that is supplied from the photo sensor 9a to the external control circuit.

Referring then to FIG. 13, the operation of image acquisition (particularly, the operation of the signal processing unit 15) with the movement of the photo sensor 9a is described hereinbelow.

At time t1, the signal S1 exceeds the threshold TH. Then, the comparator 15a outputs the high level signal S2. The reading processing section 15b then outputs the high level signal S3. After that, the photo sensor 9a outputs an image P1 that is acquired at the time when the high level signal S3 is input as the signal S4. The signal S4 that is output from the signal processing unit 15 is stored as an accumulated image in an external storage device (semiconductor memory). The image P1 is an image corresponding to the region R10 of FIG. 11.

At time t2, the signal S1 exceeds the threshold TH. Then, the comparator 15a outputs the high level signal S2. The reading processing section 15b then outputs the high level signal S3. After that, the photo sensor 9a outputs an image P4 that is acquired at the time when the high level signal S3 is input as the signal S4. The signal S4 that is output from the signal processing unit 15 is stored as the accumulated image in the external storage device (semiconductor memory). Thus, the image P1 and the image P4 are stored as the accumulated images in the external semiconductor memory. The image P4 is an image corresponding to the region R11 of FIG. 11.

At time t3, the signal S1 exceeds the threshold TH. Then, the comparator 15a outputs the high level signal S2. The reading processing section 15b then outputs the high level signal S3. After that, the photo sensor 9a outputs an image P7 that is acquired at the time when the high level signal S3 is input as the signal S4. The signal S4 that is output from the signal processing unit 15 is stored as the accumulated image in the external storage device (semiconductor memory). Thus, the image P1, the image P4 and the image P7 are stored as the accumulated images in the external semiconductor memory. The image P7 is an image corresponding to the region R12 of FIG. 11.

Based on such processing, the images P1 to PX are accumulated externally. In this embodiment, the pattern 14 has regularity. Specifically, the light reflecting portions 14b are formed at regular intervals. With use of the regular pattern 14, the amount of movement of the photo sensor 9a is detected, thereby acquiring the vein image of the finger 100 in a desired range without excess or shortage.

In this embodiment, the carrier member 5 is moved using the spring 6 made of a shape-memory alloy. The shape-memory alloy contracts according to the temperature. It is, however, difficult to accurately control the temperature of the shape-memory alloy. This is because the characteristics of the shape-memory alloy spring would vary, and the temperature is affected by the environment in use.

In this embodiment, an image is output from the photo sensor 9a using the regular pattern 14. Thus, even if the moving speed of the photo sensor 9a is not constant, it is possible to acquire the image of a necessary range at an appropriate timing. Specifically, an image to be read is not affected even if the time interval between t1 and t2 and the time interval between t2 and t3 are not the same. In this manner, it is possible to acquire the vein image of the finger 100 in a desired range without excess or shortage.

The specific structure of the signal processing unit 15 is arbitrary. An analog signal that is output from the pixel of the photo sensor 9a may be converted into a digital signal by the A-D converter and then connected to the comparator 15a and the reading processing section 15b described above. The comparator 15a and the reading processing section 15b may be implemented by software.

Further, the photo sensor 9a may execute image acquisition based on the signal S3 transmitted from the reading processing section 15b and output an acquired image. In this case, the photo sensor 9a executes image acquisition for a necessary period only. It is thus possible to reduce power consumption of the photo sensor 9a.

Furthermore, some regularity (periodicity) may be set to the pattern 14. A means of detecting a change in the periodicity set to the pattern 14 may be different from an optical method (e.g. a magnetic method). Further, another sensor that detects a change in the pattern 14 may be placed.

Referring now to FIGS. 14 and 15, the structure and the operation of the biometric authentication apparatus 80 into which the biometric information acquisition apparatus 70 is incorporated is schematically described hereinbelow.

As shown in FIG. 14, the biometric authentication apparatus 80 includes a processing unit 81, an authentication execution unit 82, an image formation unit 83, a storage unit 84, a light emitting unit 85, a vein image acquisition unit 86, and a fingerprint detection unit 87. The light emitting unit 85 is equivalent to the light emitting device 8. The vein image acquisition unit 86 is equivalent to the biometric information acquisition apparatus 70. The biometric authentication apparatus 80 is configured by a general computer with the biometric information acquisition apparatus as an interface. The biometric authentication apparatus 80 is not limited to the structure shown in FIG. 14.

The biometric authentication apparatus 80 operates as shown in FIG. 15. The biometric authentication apparatus 80 is incorporated in the cellular phone 60 shown in FIG. 1.

First, the cellular phone 60 in which the biometric authentication apparatus 80 is incorporated is in a non-operating state.

Next, the biometric authentication function of the cellular phone 60 is activated (S1). A specific method of activating the biometric authentication function is arbitrary. For example, the biometric authentication function may be activated when a user presses a certain button of the cellular phone 60. When the biometric authentication function is activated, the finger 100 is placed on the front surface of the cover plate 12.

Following the activation of the biometric authentication function, the movement of the photo sensor 9a is started (S2). Specifically, pulse current is applied to the springs 6a and 6b, so that the springs 6a and 6b are heated to contract. At this time, the light emitting device 8 outputs a near infrared ray. Further, the photo sensor 9a acquires an image at a prescribed frame rate.

Then, image reading is executed (S3). A procedure to read the image from the photo sensor 9a is as described in FIG. 13.

After that, the image formation unit 83 forms a vein image for authentication (S4). In this embodiment, a desired vein image is restored by coupling the images that are sequentially output from the photo sensor 9a (the signal processing unit 15). Thus, the image formation unit 83 does not need to perform image processing in consideration of an overlapping part of the acquired images. By acquiring the image of just enough with the photo sensor 9a using the regular pattern, it is possible to reduce the processing load of the image formation unit 83.

Then, the authentication execution unit 82 executes authentication (S5). Specifically, the authentication execution unit 82 executes biometric authentication based on the authentication image that is output from the image formation unit 83 and the vein image that is previously stored in the storage unit 84. For example, the authentication execution unit 82 determines that the authentication is succeeded if the number of parts where the way the veins are branched matches between the images is equal to or more than N (N is a natural number of 2 or above), and it determines that the authentication is failed if the number of parts where the way the veins are branched matches between the images is less than N (S6). Because a specific method of authentication depends on an image processing method, it is not limited to the above example.

If the authentication is succeeded, the function of the cellular phone that incorporates the biometric authentication apparatus 80 is activated (S7). Then, the cellular phone returns to a normal operating state. If, on the other hand, the authentication is failed, the cellular phone that incorporates the biometric authentication apparatus 80 remains in the non-operating state.

By incorporating the biometric authentication apparatus 80 into the cellular phone, the security of the cellular phone increases significantly.

As obvious from the above description, in this embodiment, by moving the photo sensor in the direction perpendicular to the pixel arrangement direction of the pixel row of the photo sensor, it is possible to acquire the vein image in the desired range exceeding the range where the photo sensor can capture an image. Further, by moving the photo sensor using a shape-memory alloy, it is possible to implement the drive mechanism of a simpler configuration. Furthermore, by placing a guide member such as the rail, it is possible to stabilize the movement of the photo sensor. By detecting the amount of movement of the photo sensor using the regular pattern and outputting the acquired image from the photo sensor based on the detection result, it is possible to reduce the load of the subsequent image processing. Further, by containing the connector 11 partly in the opening of the base plate 1, it is possible to reduce the thickness of the biometric information acquisition apparatus 70.

### Second Embodiment

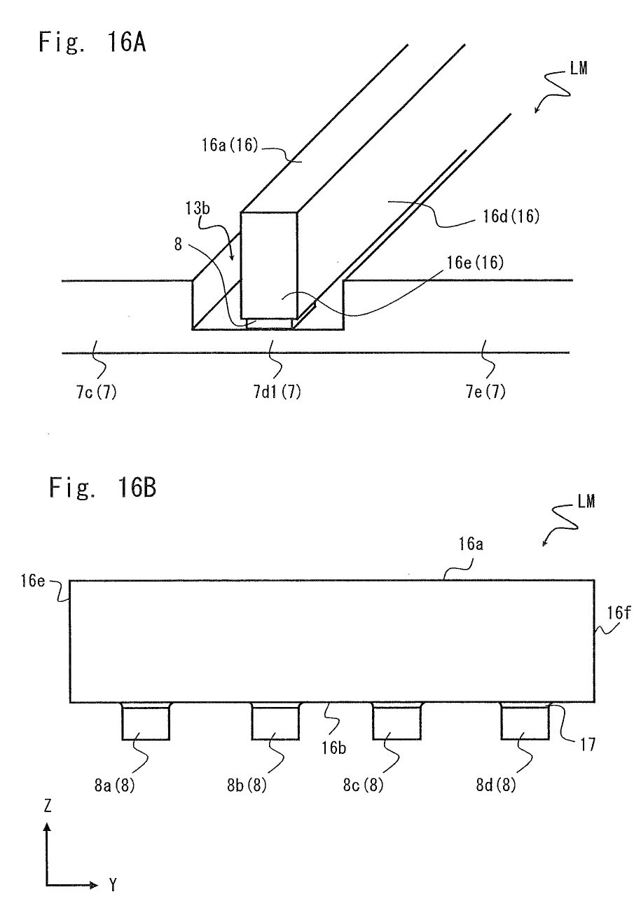

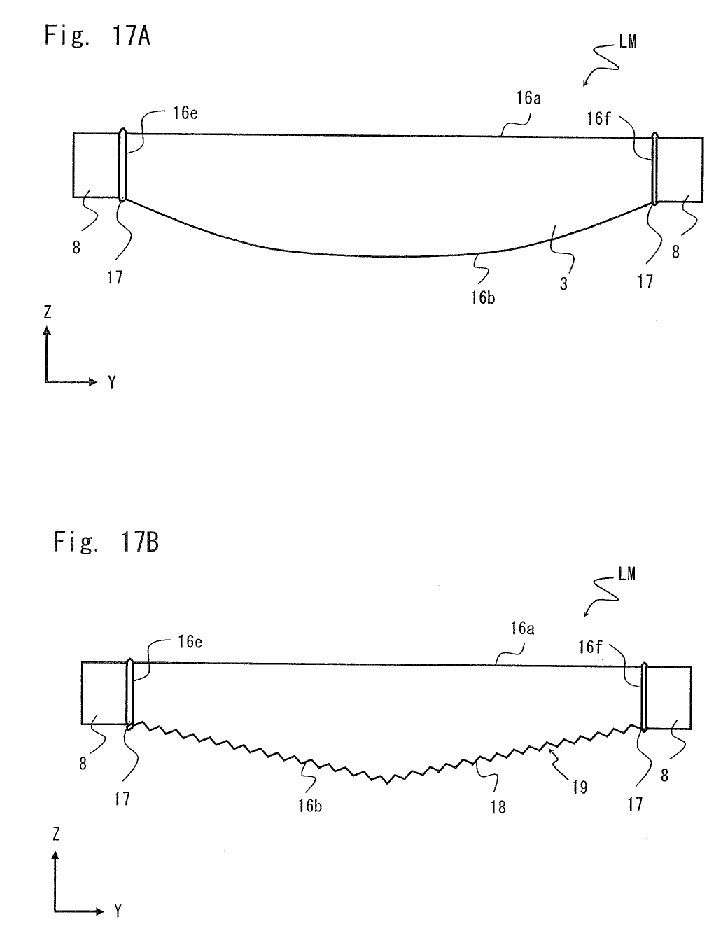

A second embodiment of the present invention is described hereinafter with reference to FIGS. 16A to 17B. FIG. 16A is a partially enlarged schematic perspective view of the illuminator. FIG. 16B is a view showing the schematic structure of the illuminator. FIGS. 17A and 17B are diagrams to describe variations of the illuminator.

As shown schematically in FIG. 16A, the illuminator LM is partially contained in the recessed portion of the container member 7. The thin portion 7d1 is formed between the thick portion 7c and the thick portion 7e.

As shown in FIG. 16A, the illuminator LM includes the light emitting device 8 and a light guide 16.

The light guide 16 is placed on the upper surface of the light emitting device 8. The light guide 16 is a plate light guiding member, and it is substantially transparent to the output light from the light emitting device 8. The light guide 16 has side surfaces 16c, 16d, 16e and 16f. The light guide 16 also has a front surface 16a and a back surface 16b.

As shown in FIG. 16B, a plurality of light emitting devices 8 are arranged at substantially equal intervals on the back surface 16b of the light guide 16 with an adhesive 17 interposed therebetween. In this manner, more uniform light is output from a light output surface 16a of the light guide 16 along the longitudinal direction of the light output surface 16a. It is thereby possible to improve the quality of the image acquired by the photo sensor 9a. If a positioning portion is previously set to the light guide 16, the light emitting devices 8 may be arranged at prescribed intervals.

Alternatively, light guides shown in FIGS. 17A and 17B may be used.

Referring to FIG. 17A, the width of the middle part of the light guide 16 is larger than the width of the left and right end part of the light guide 16 when viewed from the front. It is thereby possible to reduce a reflection loss on the back surface 16b. In such a case, the light emitting device 8 is fixed to the side surface 16e by the adhesive 17 and fixed to the side surface 16f by the adhesive 17.

Referring to FIG. 17B, a plurality of grooves 19 are formed on the back surface 16b, which is different from FIG. 17A. The grooves 19 extend in the thickness direction of the light guide 16. Because of the plurality of grooves 19 formed on the back surface 16b of the light guide 16, a plurality of reflecting surfaces 18 are formed. The output light from the light emitting device 8 is totally reflected by each reflecting surface 18 and guided to the front surface 16a.

By appropriately setting the arrangement intervals of the reflecting surfaces 18, it is possible to reduce a light loss in the light guide 16 as much as possible. This contributes to reducing power consumption of the biometric information acquisition apparatus 70. Further, by appropriately setting the arrangement intervals of the reflecting surfaces 18, it is possible to make the output light intensity in the longitudinal direction of the front surface 16a more uniform.

### Third Embodiment

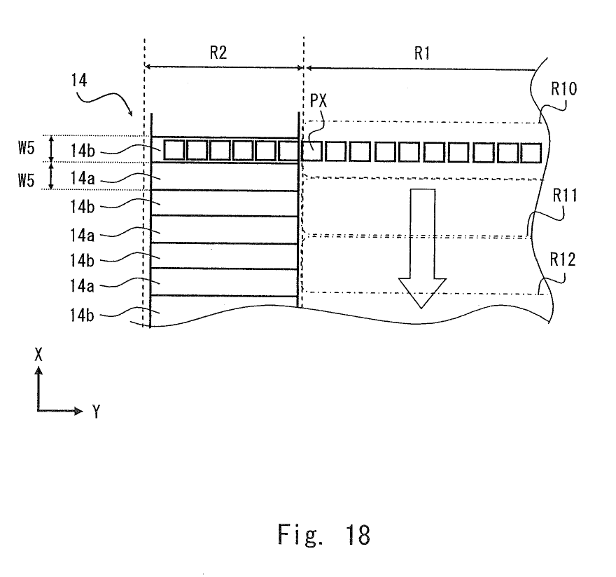

A third embodiment of the present invention is described hereinafter with reference to FIG. 18. FIG. 18 is a schematic explanatory view showing the relationship of the pattern 14 and the pixel row. This embodiment is different from the first embodiment in the structure of the pattern 14. In this embodiment, a width along the x-axis of the light absorbing portion 14a and a width along the x-axis of the light reflecting portions 14b are both a width W5, which is the same. In such a case also, it is possible to obtain the same advantage as in the first embodiment.

### Fourth Embodiment

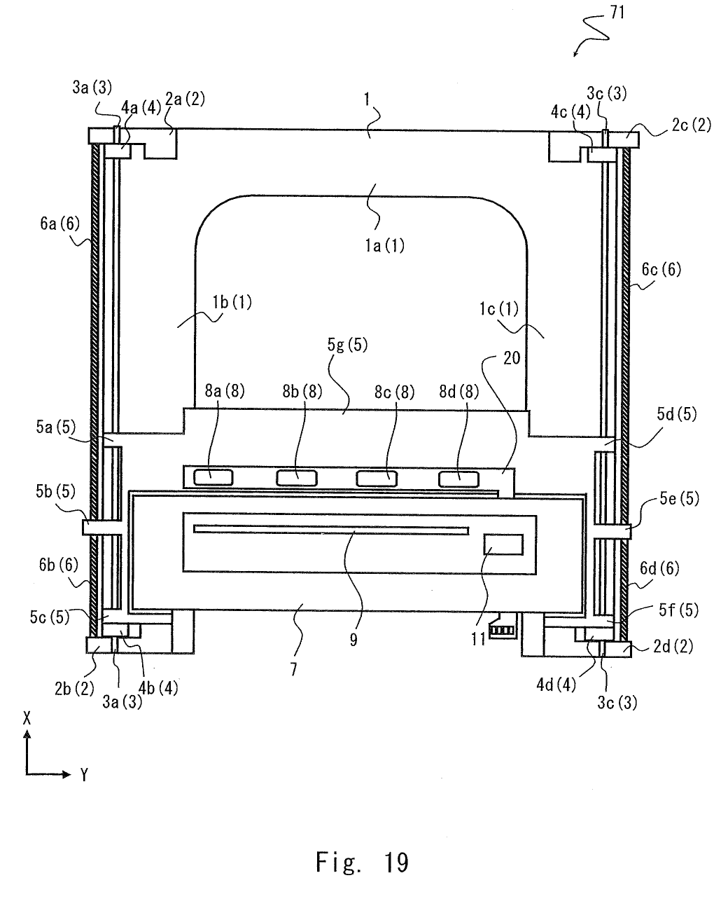

A fourth embodiment of the present invention is described hereinafter with reference to FIG. 19. FIG. 19 is a schematic diagram showing the structure of the top face of a biometric information acquisition apparatus 71. This embodiment is different from the first embodiment in the position of the light emitting device 8. In this embodiment, the light emitting device 8 is contained in the carrier member 5. In such a case also, it is possible to obtain the same advantage as in the first embodiment. The carrier member 5 and the container member 7 may be formed integrally, and the light detecting module 9 and the light emitting device 8 may be contained in different members.

Further, the light emitting device 8 is mounted on a flexible film wiring 20. By ensuring an electrical connection using a flexible wiring board, it is possible to reduce the effect of physical stress that is given to the wiring board by the movement of the carrier member 5.

### Fifth Embodiment

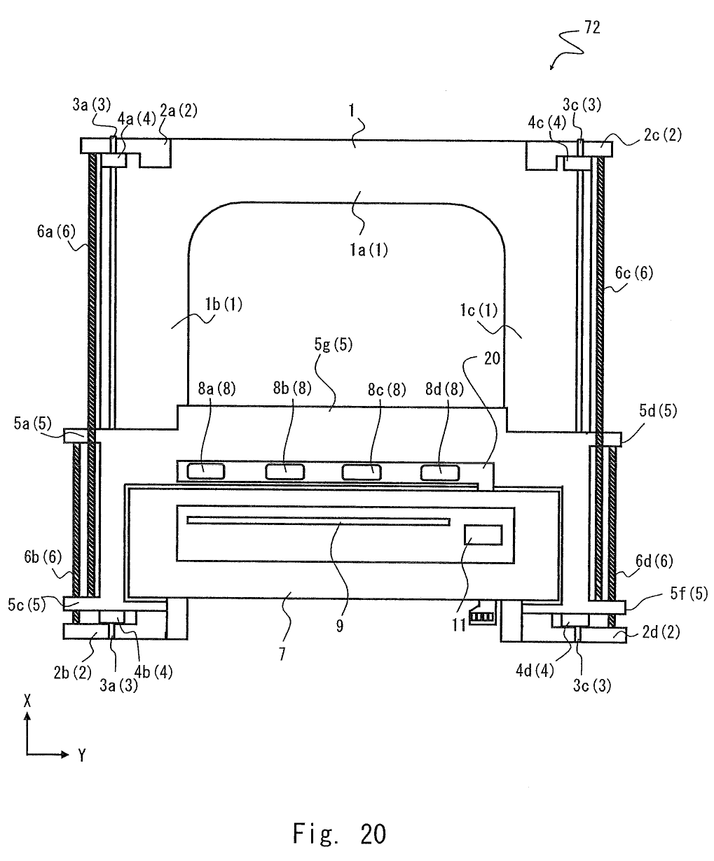

A fifth embodiment of the present invention is described hereinafter with reference to FIG. 20. FIG. 20 is a schematic diagram showing the structure of the top face of a biometric information acquisition apparatus 72. This embodiment is different from the fourth embodiment in the way of placing the spring 6, and, accordingly, in the structure of the carrier member 5.

If the length of the spring 6 increases, a larger tensile force is applied to the spring 6. In light of this, in this embodiment, a pair of springs extending from the opposite support portions to the inside have a part where the springs lie in parallel with each other. Specifically, the spring 6a extending from the support portion 2a to the inside is fixed to the thick plate portion 5c of the carrier member 5, and the spring 6b extending from the support portion 2b to the inside is fixed to the thick plate portion 5a of the carrier member 5, so that the spring 6a and the spring 6b are placed in parallel between the support portion 2a and the support portion 2b. It is thereby possible to increase the coil length of the springs 6a and 6b, thus increasing the tensile force of the springs 6a and 6b. The above description holds true for the pair of springs 6c and 6d on the right side. The redundant description is omitted.

The springs 6b and 6d may be made of the same shape-memory alloy as the springs 6a and 6c. In this case, however, it is necessary to apply pulse current to the springs 6b and 6d also in order to return to the state of FIG. 3 from the state of FIG. 4, which increases power consumption of the biometric information acquisition apparatus 70. If one of a pair of coils is a shape-memory alloy coil and the other one of the pair of coils is a normal coil as in the first embodiment, it is possible to reduce power consumption of the biometric information acquisition apparatus 70. The positions of the springs 6a to 6d are arbitrary.

### Sixth Embodiment

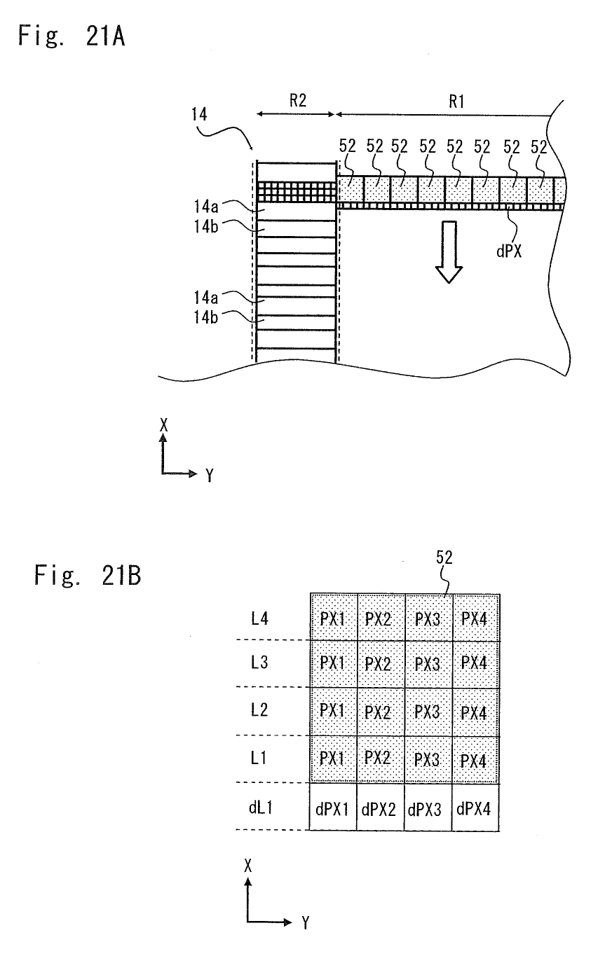

A sixth embodiment of the present invention is described hereinafter with reference to FIGS. 21A and 21B. FIG. 21A is an explanatory view showing the relationship of the photo sensor, the lens and the pattern. FIG. 21B is an explanatory view showing the relationship of the lens and the pixels.

This embodiment is different from the third embodiment in using an area sensor 9c having four pixel rows as shown in FIG. 21A. The area sensor is a photo sensor that includes a plurality of pixel rows, each row having a plurality of pixels. The area sensor 9c has one pixel row composed of pixels dPX above which the lens 52 is not placed. Further, four pixel rows L1 to L4 are placed corresponding to one lens 52 as shown in FIG. 21B. Furthermore, one pixel low dL1 above which the lens 52 is not formed is placed. The lens 52 is placed above the pixels PX, and the lens 52 is not placed above the pixels dPX.

By placing the plurality of pixels PX corresponding to one lens 52, even if a certain pixel PX is damaged, another pixel PX corresponding to the same lens 52 can be used for image acquisition. It is thereby possible to enhance the reliability of the product of the biometric information acquisition apparatus 70.

Further, by placing the pixels dPX above which the lens 52 is not placed, a background component can be subtracted from the image acquired through the lens 52. By executing such image processing, it is possible to further increase the quality of the vein image for authentication.

### Seventh Embodiment

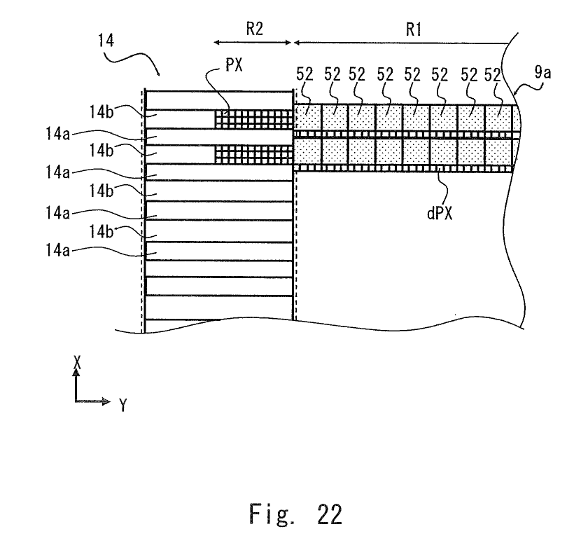

A seventh embodiment of the present invention is described hereinafter with reference to FIG. 22. FIG. 22 is an explanatory view showing the relationship of the photo sensor, the lens and the pattern. This embodiment is different from the sixth embodiment in that two lens rows are placed, and an area sensor 9d including ten pixel rows is used. By placing a plurality of lens rows and preparing a plurality of pixels corresponding thereto, it is possible to acquire the vein image of a larger range at a time. This reduces the load of the subsequent image processing. Further, even if a pixel placed corresponding to one lens row becomes defective, it is possible to execute vein image acquisition using a pixel placed corresponding to the other lens row.

### Eighth Embodiment

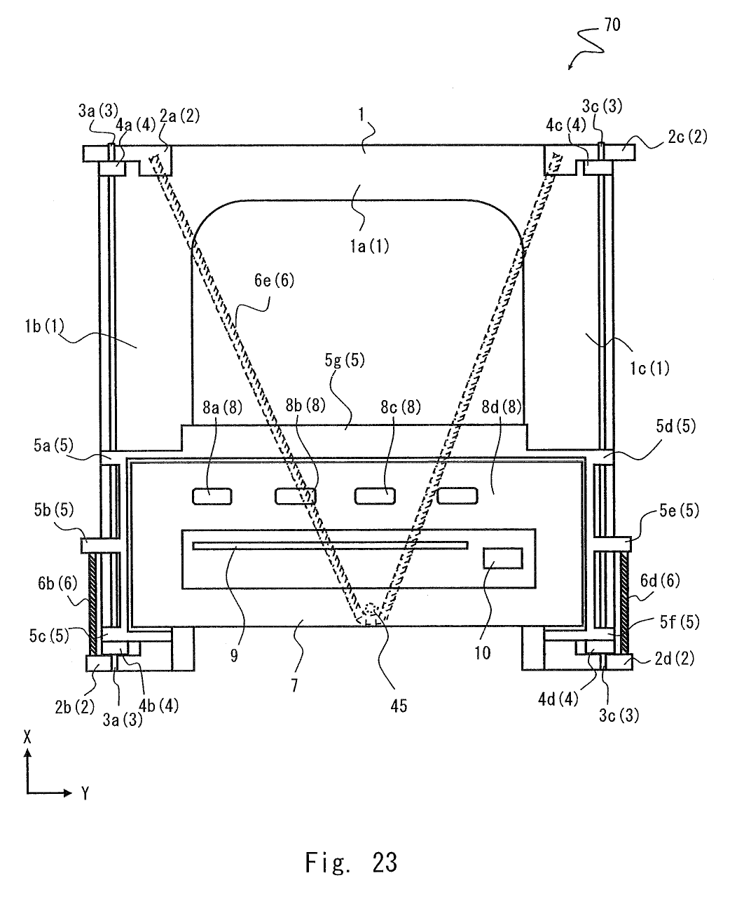

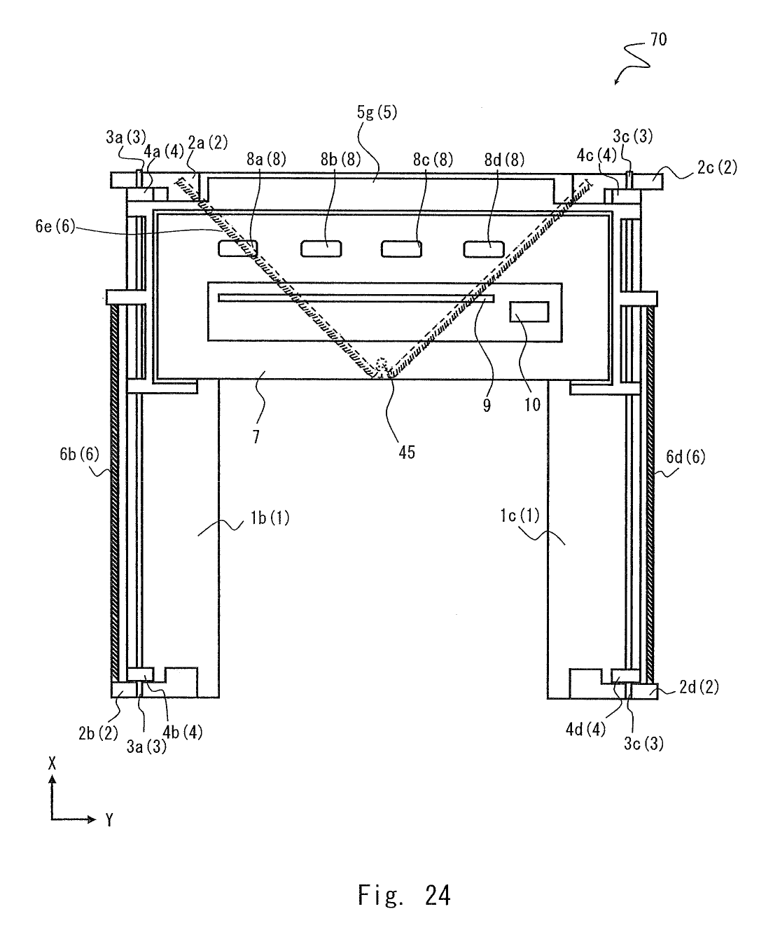

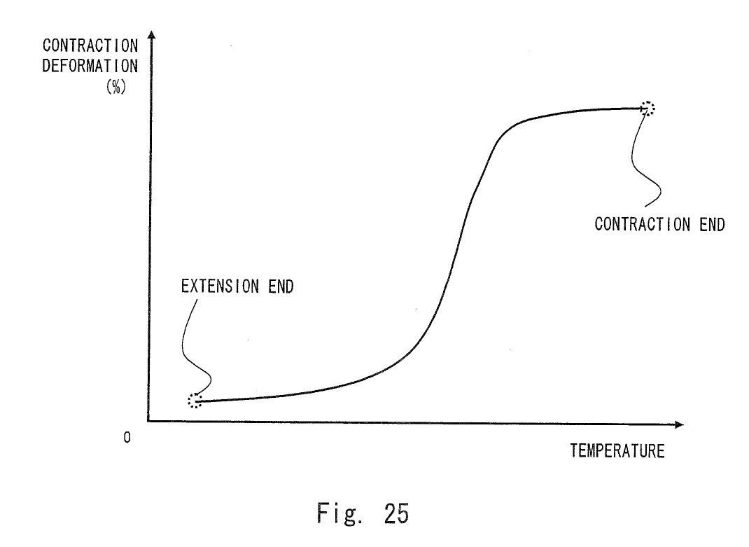

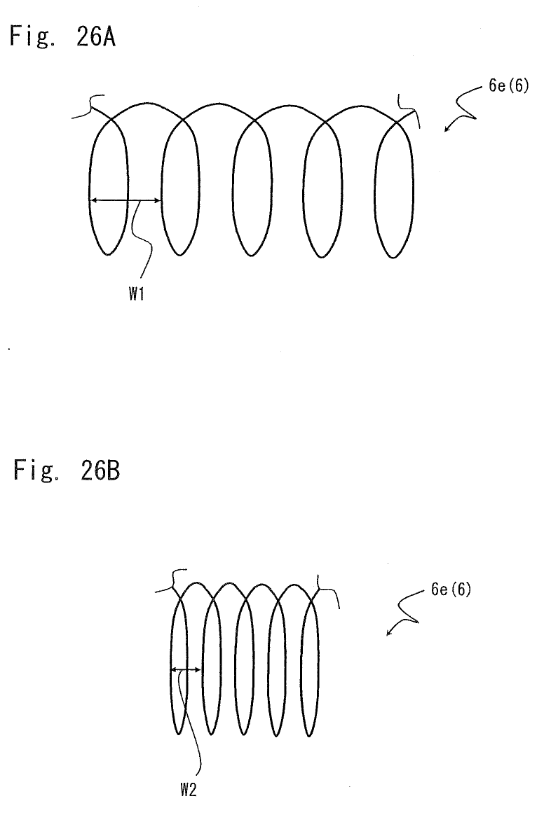

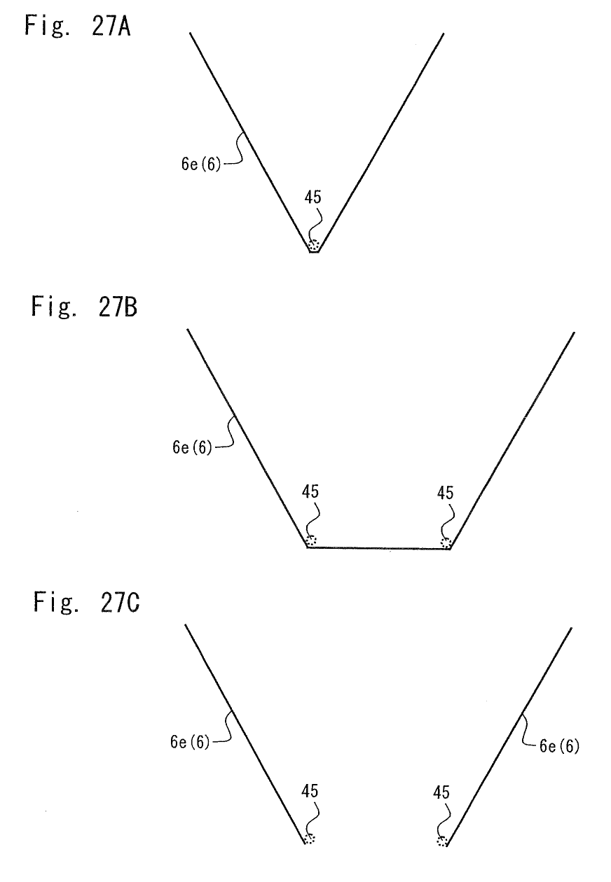

An eighth embodiment of the present invention is described hereinafter with reference to FIGS. 23 and 27C. FIG. 23 is a schematic diagram showing the structure of the biometric information acquisition apparatus before the photo sensor moves. FIG. 24 is a schematic diagram showing the structure of the biometric information acquisition apparatus after the photo sensor has moved. FIG. 25 is a graph showing the characteristics of the spring. FIGS. 26A and 26B are explanatory views to describe the extension and the contraction of the spring. FIGS. 27A to 27C are explanatory views showing variations of placement of the spring.

In this embodiment, a spring 6e is placed instead of the springs 6a and 6c, differently from the above-described embodiments. Like the springs 6a and 6c, the spring 6e is a coil member formed by winding a linear Ti—Ni or Ti—Ni—Cu alloy (shape-memory alloy) into a coil. It is thereby possible to ensure a force (stroke) necessary for moving the photo sensor 9a. It is further possible to reduce the amount of current necessary for moving the photo sensor 9a, thereby effectively reducing power consumption of the biometric information acquisition apparatus. This is described in detail hereinbelow.

FIG. 23 is a schematic diagram showing the structure of the biometric information acquisition apparatus before the photo sensor moves. FIG. 24 is a schematic diagram showing the structure of the biometric information acquisition apparatus after the photo sensor has moved.

As shown in FIGS. 23 and 24, the spring 6e is V-shaped when viewed from above. The spring 6e is engaged with a protrusion 45 formed on the back surface of the carrier member 5. One end of the spring 6e is fixed to the back surface of the base plate 1 (the backside of the support portion 2a). The other end of the spring 6e is fixed to the back surface of the base plate 1 (the backside of the support portion 2c). A method of fixing the end of the spring 6e to the base plate 1 is arbitrary. For example, the end of the spring 6e may be fixed to the base plate 1 by attaching a ring form at the end of the spring 6e and then attaching the ring form to a projecting portion formed on the base plate 1. Alternatively, the end of the spring 6e may be fixed to the base plate 1 by an adhesive or the like.

The base plate 1 and the carrier member 5 are connected to each other by the spring 6e. To the spring 6e, a line for passing current from one end to the other end of the spring 6e is connected, though not shown.

The spring 6e extends in the direction intersecting the moving direction of the carrier member 5 (the photo sensor 9a). The spring 6e extends obliquely downward to the right from one end to the protrusion 45 and further extends obliquely upward to the right from the protrusion 45 to the other end.

In this embodiment, the spring 6e extends in the direction intersecting the moving direction of the carrier member 5. It is thereby possible to effectively increase the amount of movement of the carrier member 5 with respect to the amount of extension and contraction of the spring 6e.

Further, the protrusion 45 is located farther than the photo sensor 9a from each end of the spring 6e. By placing the protrusion 45 in such a position, it is possible to increase the length of the spring 6e.

Furthermore, in the state after the carrier member 5 has moved, the spring 6e still extends in the direction intersecting the moving direction of the carrier member 5, and the spring 6e does not completely contract. It is thereby possible to effectively reduce a power necessary for moving the carrier member 5.

The reduction of power consumption is described hereinafter with reference to FIG. 25. As shown in FIG. 25, the shape-memory alloy that forms the spring 6e has the “S” characteristics. By passing current through the spring 6e and increasing the temperature of the spring 6e, the spring 6e contracts. In order to make the spring 6e completely contract, it is necessary to pass excessive current through the spring 6e. This is because the amount of contraction deformation with respect to temperature change becomes smaller toward the contraction end point.

In light of this, in this embodiment, the carrier member 5 is moved to a desired position as shown in FIG. 24 without contracting the spring 6e completely. It is thereby possible to reduce the amount of current necessary for moving the carrier member 5 and, consequently, reduce power consumption of the biometric information acquisition apparatus.

When the spring 6e contracts completely, a spiral metal line forming the spring 6e is placed highly densely along the extending direction of the spring 6e, so that there is no or an extremely narrow interval between adjacent metal line parts.

The extension and contraction of the spring 6e are described hereinafter with reference to FIG. 26. When the carrier member 5 is at the initial position (the state shown in FIG. 23), the interval of the metal line forming the spring 6e is W1 as shown in FIG. 26A. On the other hand, when the carrier member 5 is at the position after movement (the state shown in FIG. 24), the interval of the metal line forming the spring 6e is W2 as shown in FIG. 26B. The intervals W1 and W2 have the relationship of W2<W1, where W1 is a positive integer and W2 is 0 or a positive integer.

In the state of FIG. 26B, the spring 6e does not yet contract completely. In this embodiment, in light of the characteristics of the shape-memory alloy described above (cf. FIG. 25), the carrier member 5 is moved from the position shown in FIG. 23 to the position shown in FIG. 24 without completely contracting the spring 6e. It is thereby possible to move the carrier member 5 in a desired range and effectively suppress an increase in power consumption of the biometric information acquisition apparatus.

The way of placing the spring 6e is described hereinafter with reference to FIGS. 27A to 27C.

As shown in FIG. 27A, the spring 6e may be engaged with the carrier member 5 by the protrusion 45 at one point (this case corresponds to the present embodiment). As shown in FIG. 27B, the spring 6e may be engaged with the carrier member 5 by the protrusions 45 at two points. As shown in FIG. 27C, a plurality of springs 6e may be prepared, and each spring 6e may be engaged with each protrusion 45 individually. When using the plurality of springs 6e, it is necessary to connect a line for passing current through each spring 6e to each spring 6e.

### Ninth Embodiment

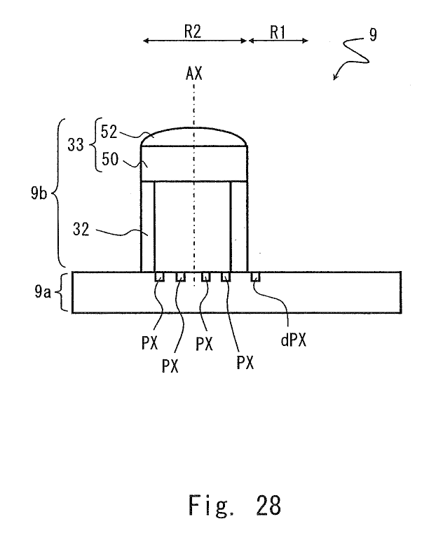

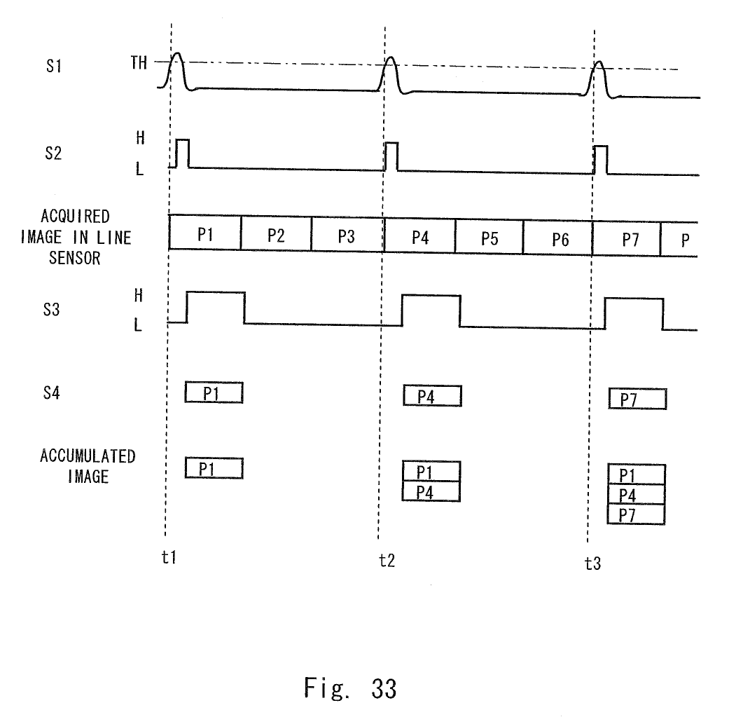

A ninth embodiment of the present invention is described hereinafter with reference to FIGS. 28 and 33.

In order to implement highly accurate vein authentication, it is necessary to acquire a high quality vein image. By placing the condenser lenses respectively corresponding to the pixels, it is possible to suitably capture a vein image at a prescribed depth below the skin. However, the environment where the biometric information acquisition apparatus is used varies, and there is a possibility that highly intense background light would be input to the pixel of the photo sensor. In such a case, the quality of the acquired vein image can be partly degraded due to the effect of the background light input to the pixel. As a result, this can hinder the implementation of highly accurate vein authentication.

This embodiment particularly aims at preventing the degradation of the quality of an acquired image due to the effect of the background light.

FIG. 28 shows the schematic cross-sectional structure of the light detecting module 9. As shown in FIG. 28, the light detecting module 9 is an optical element in which the optical functional portion 9b is placed on top of the photo sensor 9a. Further, the connector 11 is connected to the photo sensor 9a.

As shown in FIG. 28, the photo sensor 9a includes a plurality of pixels PX and pixels dPX on the principal surface.

In this embodiment, the optical functional portion 9b is placed on the pixels PX. On the other hand, the optical functional portion 9b is not placed on the pixels dPX. A vein image is acquired using the plurality of pixels PX, and a background light intensity is acquired using the plurality of pixels dPX. By subtracting the output of the pixels dPX from the output of the pixels PX, a background light component contained in the output of the pixels PX can be eliminated. It is thereby possible to acquire a higher quality vein image with a simple structure.

As described above, the environment where the biometric information acquisition apparatus is used varies, and there is a possibility that highly intense background light would be input to the pixel of the photo sensor. In such a case, the quality of the acquired vein image can be degraded due to the effect of the background light input to the pixel. Consequently, the implementation of highly accurate vein authentication can be hindered. In this embodiment, by subtracting the output of the pixels dPX from the output of the pixels PX as described above, a background light component contained in the output of the pixels PX can be eliminated. It is thereby possible to acquire a higher quality vein image with a simple structure.

The optical functional portion 9b is placed on the pixels PX. The optical functional portion 9b includes the optical channel separation layer 32 and the microlens array 33. The microlens array 33 includes the transparent substrate 50 and the lenses (condenser lenses) 52. The optical channel separation layer 32 has a light shielding wall that extends along the optical axis of the lens 52 so as to surround the optical axis. The part surrounded by the light shielding wall is optically transparent.

The transparent substrate 50 and the lens 52 are made of a material that is substantially transparent to the inspection light. The transparent substrate 50 is a quartz substrate. The lens 52 is an optical element that is formed by partially removing a resist layer deposited on the transparent substrate 50 by photolithography using a grayscale mask. By placing the microlens array 33 above the pixel PX, it is possible to suitably capture a vein image located at a prescribed depth below the skin of the finger 100.

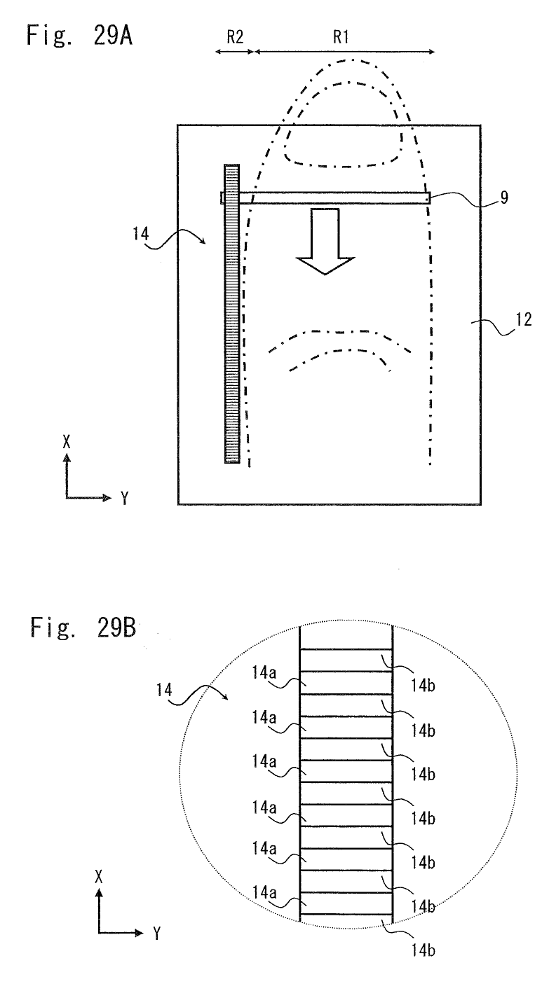

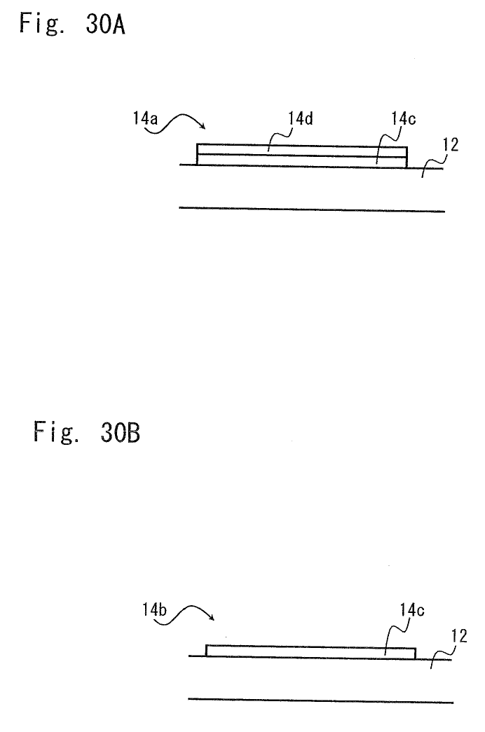

Referring then to FIGS. 29A to 33, the pattern formed on the back surface of the cover plate 12 and the operation of reading an image signal from the photo sensor 9a using the pattern are described hereinbelow. FIG. 29A is a schematic view showing the structure of the pattern formed on the cover plate 12. FIG. 29B is a partially enlarged schematic view of the pattern. FIGS. 30A and 30B are schematic views showing the laminated structure of the pattern.

As shown in FIG. 29A, the regular pattern 14 is formed on the back surface of the cover plate 12.

As shown in FIG. 29B, the pattern 14 includes the light absorbing portion 14a and the light reflecting portion 14b. The light absorbing portion 14a absorbs a near infrared ray that is output from the light emitting device 8. The light reflecting portion 14b reflects a near infrared ray that is output from the light emitting device 8.

The pattern 14 is a band-like pattern with a constant width. The plurality of light reflecting portions 14b included in the pattern 14 are arranged at regular intervals.

FIG. 30A shows the laminated structure of the light absorbing portion 14a. FIG. 30B shows the laminated structure of the light reflecting portion 14b. As shown in FIG. 30A, the light absorbing portion 14a is a lamination in which the black resin layer 14d is formed on top of the metal layer 14c. As shown in FIG. 30B, the light reflecting portion 14b is made of the metal layer 14c. The light reflecting portion 14b is formed by regularly patterning the black resin layer 14d as shown in FIG. 29B so that the metal layer 14c is partly exposed between the black resin layer 14d.

The metal layer 14c is formed on the back surface of the cover plate 12. The light absorbing portion 14a is a part where the patterned black resin layer 14d is not removed. The pattern 14 is formed using normal thin film formation technique and patterning technique.

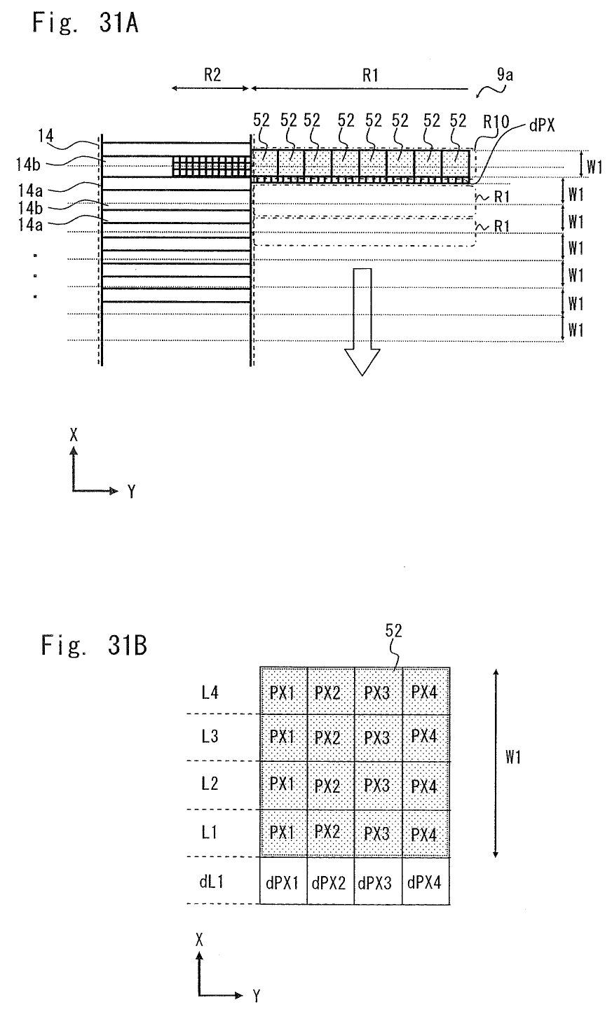

FIG. 31A shows the relationship of the pixel row of the photo sensor 9a and the pattern 14. The pixel row is formed across the region R1 where the pattern 14 is not formed and the region R2 where the pattern 14 is formed. The pixel row is placed in parallel with the longitudinal direction of the light reflecting portion 14b.

When the pixel row moves as indicated by the arrow of FIG. 31A, the pixel PX in the region R2 passes the light absorbing portion 14a and the light reflecting portion 14b alternately. During the moving period of the photo sensor 9a, the light emitting device 8 emits light. Thus, as the pixel PX in the region R2 comes closer to the light reflecting portion 14b, an output value from the pixel PX in the region R2 increases. The light reflecting portions 14b are arranged regularly at prescribed intervals. Therefore, the amount of movement of the photo sensor 9a can be detected based on the output from the pixel PX in the region R2. As a result, it is possible to output an image from the photo sensor 9a at an appropriate timing. The intervals of the light reflecting portions 14b are set to the same as the lens width W1 along the x-axis of the lens 52.

FIG. 31B shows the positional relationship of the lens 52 and the pixels. As shown in FIG. 31B, the four pixel rows L1 to L4 are arranged below one lens 52. Further, one pixel row dL1 that includes the pixels dPx is arranged under the first pixel row L1. The lens 52 is placed above the pixels indicated by dots. Thus, the lens 52 is placed above the pixel rows L1 to L4, and the lens 52 is not placed above the pixel row dL1.

By placing the plurality of pixels PX corresponding to one lens 52, even if a certain pixel PX is damaged, another pixel PX corresponding to the same lens 52 can be used for image acquisition. It is thereby possible to enhance the reliability of the product of the biometric information acquisition apparatus 70. Further, by placing the pixels dPX above which the lens 52 is not placed, a background component can be subtracted from the image acquired through the lens 52. By executing such image processing, it is possible to further increase the quality of the vein image for authentication.

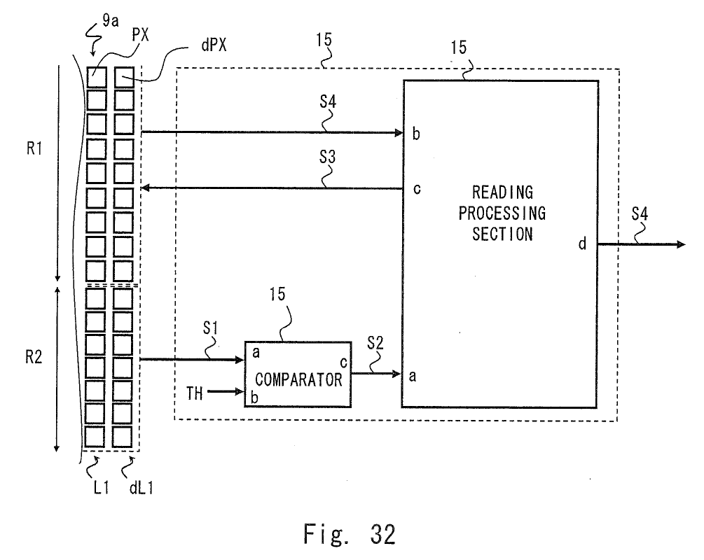

FIG. 32 shows the schematic structure of the signal processing unit that is connected to the photo sensor 9a. As shown in FIG. 32, the signal processing unit 15 includes the comparator 15a and the reading processing section 15b. The A-D converter 10 is not shown for convenience of description.

The signal processing unit 15 is connected as follows. An output from the pixel in the region R2 is connected to the input a of the comparator 15a. The threshold is input to the input b of the comparator 15a. The output c of the comparator 15a is connected to the input a of the reading processing section 15b. An output from the pixel in the region R1 is connected to the input b of the reading processing section 15b. The output c of the reading processing section 15b is connected to the photo sensor 9a. The output d of the reading processing section 15b is connected to the external control circuit.

The comparator 15a compares the signal S1 that is output from the pixel in the region R2 with the threshold TH that is set in advance. If the signal S1 exceeds the threshold TH, the comparator 15a outputs the high level signal (timing detection signal) S2.

When the high level signal S2 is supplied from the comparator 15a, the reading processing section 15b outputs the high level signal (read instruction signal) S3 to the photo sensor 9a.

The photo sensor 9a executes image acquisition at prescribed cycles. When the high level signal S3 is supplied from the reading processing section 15b, the photo sensor 9a outputs the signal S4 that is accumulated at that time to the input b of the reading processing section 15b. The reading processing section 15b outputs the signal S4 that is supplied from the photo sensor 9a to the external control circuit.

Referring then to FIG. 33, the operation of image acquisition (particularly, the operation of the signal processing unit 15) with the movement of the photo sensor 9a is described hereinbelow.

At time t1, the signal S1 exceeds the threshold TH. Then, the comparator 15a outputs the high level signal S2. The reading processing section 15b then outputs the high level signal S3. After that, the photo sensor 9a outputs the image P1 that is acquired at the time when the high level signal S3 is input as the signal S4. The signal S4 that is output from the signal processing unit 15 is stored as an accumulated image in the external storage device (semiconductor memory). The image P1 is an image corresponding to the region R10 of FIG. 31A.

At time t2, the signal S1 exceeds the threshold TH. Then, the comparator 15a outputs the high level signal S2. The reading processing section 15b then outputs the high level signal S3. After that, the photo sensor 9a outputs the image P4 that is acquired at the time when the high level signal S3 is input as the signal S4. The signal S4 that is output from the signal processing unit 15 is stored as an accumulated image in the external storage device (semiconductor memory). Thus, the image P1 and the image P4 are stored as the accumulated images in the external semiconductor memory. The image P4 is an image corresponding to the region R11 of FIG. 31A.

At time t3, the signal S1 exceeds the threshold TH. Then, the comparator 15a outputs the high level signal S2. The reading processing section 15b then outputs the high level signal S3. After that, the photo sensor 9a outputs the image P7 that is acquired at the time when the high level signal S3 is input as the signal S4. The signal S4 that is output from the signal processing unit 15 is stored as an accumulated image in the external storage device (semiconductor memory). Thus, the image P1, the image P4 and the image P7 are stored as the accumulated images in the external semiconductor memory. The image P7 is an image corresponding to the region R12 of FIG. 31A.

Based on such processing, the images P1 to PX are accumulated externally. In this embodiment, the pattern 14 has regularity as described above. Specifically, the light reflecting portions 14b are formed at regular intervals. With use of the regular pattern 14, the amount of movement of the photo sensor 9a is detected, thereby acquiring the vein image of the finger 100 in a desired range without excess or shortage.

In this embodiment, the carrier member 5 is moved using the spring 6 made of a shape-memory alloy. The shape-memory alloy contracts according to the temperature. It is, however, difficult to accurately control the temperature of the shape-memory alloy. This is because the characteristics of the shape-memory alloy spring would vary, and the temperature is affected by the environment in use.

In this embodiment, an image is output from the photo sensor 9a using the regular pattern 14 as described above. Thus, even if the moving speed of the photo sensor 9a is not constant, it is possible to acquire the image of a necessary range at an appropriate timing. Specifically, an image to be read is not affected even if the time interval between t1 and t2 and the time interval between t2 and t3 are not the same. In this manner, it is possible to acquire the vein image of the finger 100 in a desired range without excess or shortage.

Further, in this embodiment, the photo sensor 9a has the plurality of pixels PX that receive light input through the lens 52 and the plurality of pixels dPX that receive light input not through the lens 52 as described above. Thus, the background light component of the image acquired by the pixel rows L1 to L4 can be subtracted based on the background light intensity acquired by the pixel row dL1. It is thereby possible to acquire a higher quality vein image with a simple structure.

A specific method of removing the background light component of the image acquired by the pixel rows L1 to L4 based on the background light intensity acquired by the pixel row dL1 is arbitrary. For example, the background light component may be corrected at the stage of image processing as in the present embodiment, or a semiconductor circuit for removing the background light component before the above processing by the signal processing unit 15 may be placed.

Further, the specific structure of the signal processing unit 15 is also arbitrary. An analog signal that is output from the pixel of the photo sensor 9a may be converted into a digital signal by the A-D converter and then connected to the comparator 15a and the reading processing section 15b described above. The comparator 15a and the reading processing section 15b may be implemented by software.

Further, the photo sensor 9a may execute image acquisition based on the signal S3 transmitted from the reading processing section 15b and output the acquired image. In this case, the photo sensor 9a executes image acquisition for a necessary period only. It is thus possible to reduce power consumption of the photo sensor 9a.

Furthermore, some regularity (periodicity) may be set to the pattern 14. A means of detecting a change in the periodicity set to the pattern 14 maybe different from an optical method (e.g. a magnetic method). Further, another sensor that detects a change in the pattern 14 may be placed.

The technological range of the present invention is not limited to the above-described embodiments. Biometric information may be acquired using a sensor different from the photo sensor. Besides the vein authentication, the present invention may be applied to fingerprint authentication. The vein authentication may be performed on another part of body, such as the palm of a hand or the foot. The drive mechanism for moving the sensor may be a drive mechanism using a motor, a link mechanism and a transfer mechanism. Further, the drive mechanism may be configured using an organic polymeric artificial muscle (conductive polymer, polymer gel, dielectric elastomer, etc.) The carrier member and the container member may be formed by a material different from resin. The microlens array may be formed on the back surface of the cover plate. The lens shape of the microlenses of the microlens array is arbitrary. The intensity or the wavelength of light output from a light source may be changed based on the output of a second pixel.

An imaging target is not limited to biometric information such as a fingerprint image and a vein image. The present invention is applicable to a general image acquisition apparatus. With use of the drive mechanism using a shape-memory alloy, it is possible to reduce the size of the image acquisition apparatus and lower the cost with a simple structure. By placing the shape-memory alloy so as to intersect the moving direction of the carrier member, it is possible to obtain a sufficient stroke.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A biometric information acquisition apparatus comprising:
a sensor that includes at least one pixel row formed from a plurality of pixels; and
a drive mechanism that moves the sensor in a direction intersecting a pixel arrangement direction of the pixel row.

2. The biometric information acquisition apparatus according to claim 1, wherein
the drive mechanism moves the sensor by extending or contracting a linear body based on electrical control.

3. The biometric information acquisition apparatus according to claim 2, wherein
the linear body comprises one of an organic polymer and a shape-memory alloy.

4. The biometric information acquisition apparatus according to claim 2, wherein
the linear body extends in a direction intersecting a moving direction of the sensor.

5. The biometric information acquisition apparatus according to claim 1, further comprising:
a guide member that guides movement of the sensor, the guide member being attached to the sensor directly or indirectly.

6. The biometric information acquisition apparatus according to claim 1, further comprising:
a regular pattern formed along a moving direction of the sensor.

7. The biometric information acquisition apparatus according to claim 6, wherein
the sensor comprises a pixel to output a value corresponding to regularity of the pattern according to movement of the sensor.

8. The biometric information acquisition apparatus according to claim 1, further comprising:
a detecting unit that detects the amount of the movement of the sensor, the sensor being controlled based on an output of the detecting unit.

9. The biometric information acquisition apparatus according to claim 1, further comprising:
a connector that connects an output of the sensor to an external circuit; and
a base member that is attached to the sensor directly or indirectly and comprises an opening to at least partly contain the connector.

10. The biometric information acquisition apparatus according to claim 1, further comprising:
a light source that outputs light to be illuminated on a subject and moves with movement of the sensor.

11. The biometric information acquisition apparatus according to claim 10, further comprising:
a plurality of light sources; and
a light guide that guides output light from the plurality of light sources.

12. The biometric information acquisition apparatus according to claim 1, further comprising:
a light source that outputs light to be illuminated on a subject; and
a plurality of lenses, wherein
the sensor is a photo sensor including a plurality of pixels corresponding to the plurality of lenses.

13. The biometric information acquisition apparatus according to claim 1, further comprising:
a light source that outputs light to be illuminated on a subject; and
a plurality of lenses, wherein
the sensor is a photo sensor including a pixel above which a lens included in the plurality of lenses is not placed.

14. Electronic equipment comprising the biometric information acquisition apparatus according to claim 1.

15. An image acquisition apparatus comprising:
a sensor that includes at least one pixel row formed from a plurality of pixels;
a linear body that is coupled to the sensor directly or indirectly; and
a drive mechanism that moves the sensor in a direction intersecting a pixel arrangement direction of the pixel row by extending or contracting the linear body based on electrical control.

16. The image acquisition apparatus according to claim 15, wherein
the linear body extends in a direction intersecting a moving direction of the sensor.

17. A biometric information acquisition apparatus comprising:
a plurality of lenses;
a photo sensor that includes a pixel row formed from a plurality of first pixels above which the lenses are placed, and at least one second pixel above which the lenses are not placed; and
a drive mechanism that moves the photo sensor in a direction intersecting a pixel arrangement direction of the pixel row.

18. A biometric information acquisition apparatus comprising:
a plurality of lenses; and
a photo sensor, the photo sensor comprising:
a plurality of first pixels that receive light input respectively through the plurality of lenses; and
a second pixel that receives light input not through a lens included in the plurality of lenses.

19. The biometric information acquisition apparatus according to claim 18, further comprising:
a drive mechanism that moves the photo sensor in a direction intersecting a pixel arrangement direction of the plurality of first pixels.

20. The biometric information acquisition apparatus according to claim 18, wherein
at least two pixels of the plurality of first pixels are arranged to receive light input through a common lens of the plurality of lenses.
